(19) United States
(12) Patent Application Publication
(10) Pub. No.: US 2021/0136406 A1
(43) Pub. Date: May 6, 2021

(54) VIDEO COMPRESSION APPARATUS, DECOMPRESSION APPARATUS AND RECORDING MEDIUM

(71) Applicant: NIKON CORPORATION, Tokyo (JP)

(72) Inventors: Masaya TAKAHASHI, Tokyo (JP); Keiichi NITTA, Kawasaki-shi (JP)

(73) Assignee: NIKON CORPORATION, Tokyo (JP)

(21) Appl. No.: 17/044,067

(22) PCT Filed: Mar. 26, 2019
(86) PCT No.: PCT/JP2019/012918

§ 371 Date: Dec. 22, 2020

(30) Foreign Application Priority Data
Mar. 30, 2018 (JP) 2018-070199

(51) Int. Cl. H04N 19/543; H04N 19/42; H04N 19/44; H04N 19/573

(52) U.S. Cl. CPC H04N 19/543; H04N 19/573; H04N 19/44; H04N 19/42

(57) ABSTRACT

A video compression apparatus configured to compress a plurality of frames outputted from an imaging element that has a first imaging region in which a subject is captured and a second imaging region in which a subject is captured, and in which a first imaging condition can be set for the first imaging region and a second imaging condition differing from the first imaging condition can be set for the second imaging region, includes: an image processing unit configured to execute image processing based on the second imaging condition on image data outputted from the first imaging region by the imaging element capturing the subject; and a compression unit configured to compress each of the frames subjected to the image processing by the image processing unit on the basis of block matching with a frame differing from the frame.

### CLAIM OF PRIORITY

The present application claims priority from Japanese patent application JP 2018-070199 filed on Mar. 30, 2018, the content of which is hereby incorporated by reference into this application.

### BACKGROUND

The present invention pertains to a video compression apparatus, a decompression apparatus, an electronic apparatus, a video compression program, and a decompression program.

Imaging apparatuses provided with imaging elements that can set differing imaging conditions for each region are known (see JP 2006-197192 A). However, video compression of frame captured under differing imaging conditions has not been considered so far.

### SUMMARY

An aspect of the disclosure of a video compression apparatus in this application is a video compression apparatus configured to compress a plurality of frames outputted from an imaging element that has a first imaging region in which a subject is captured and a second imaging region in which a subject is captured, and in which a first imaging condition can be set for the first imaging region and a second imaging condition differing from the first imaging condition can be set for the second imaging region, the video compression apparatus comprising: an image processing unit configured to execute image processing based on the second imaging condition on image data outputted from the first imaging region by the imaging element capturing the subject; and a compression unit configured to compress each of the frames subjected to the image processing by the image processing unit on the basis of block matching with a frame differing from the frame.

Another aspect of the disclosure of a video compression apparatus in this application is a video compression apparatus configured to compress a plurality of frames outputted from an imaging element that has a first imaging region in which a subject is captured and a second imaging region in which a subject is captured, and in which a first imaging condition can be set for the first imaging region and a second imaging condition differing from the first imaging condition can be set for the second imaging region, the video compression apparatus comprising: an image processing unit configured to execute image processing based on the second imaging condition on image data outputted from the first imaging region by the imaging element capturing the subject; and a compression unit configured to compress each of the frames subjected to the image processing by the image processing unit on the basis of a frame differing from the frame.

An aspect of the disclosure of a decompression apparatus in this application is a decompression apparatus configured to decompress a compressed file having compressed therein a plurality of frames outputted from an imaging element that has a first imaging region in which a subject is captured and a second imaging region in which a subject is captured, and in which a first imaging condition can be set for the first imaging region and a second imaging condition differing from the first imaging condition can be set for the second imaging region, the decompression apparatus, comprising: a decompression unit configured to decompress the compressed frame within the compressed file into the frame; and wherein the image processing unit is configured to execute image processing based on the second imaging condition and the first imaging condition for image data of a specific subject subjected to image processing based on the second imaging condition within the frame decompressed by the decompression unit.

An aspect of the disclosure of an electronic apparatus in this application is an electronic apparatus, comprising: an imaging element that has a first imaging region in which a subject is captured and a second imaging region in which a subject is captured, and in which a first imaging condition can be set for the first imaging region and a second imaging condition differing from the first imaging condition can be set for the second imaging region; an image processing unit configured to execute image processing based on the second imaging condition on image data outputted from the first imaging region by the imaging element capturing the subject; and a compression unit configured to compresses each of the frames subjected to the image processing by the image processing unit on the basis of block matching with a frame differing from the frame.

Another aspect of the disclosure of an electronic apparatus in this application is an electronic apparatus, comprising: an imaging element that has a first imaging region in which a subject is captured and a second imaging region in which a subject is captured, and in which a first imaging condition can be set for the first imaging region and a second imaging condition differing from the first imaging condition can be set for the second imaging region; an image processing unit configured to execute image processing based on the second imaging condition on image data outputted from the first imaging region by the imaging element capturing the subject; and a compression unit configured to compress each of the frames subjected to the image processing by the image processing unit on the basis of a frame differing from the frame.

An aspect of the disclosure of a video compression program in this application is a video compression program that causes a processor to execute compression on a plurality of frames outputted from an imaging element that has a first imaging region in which a subject is captured and a second imaging region in which a subject is captured, and in which a first imaging condition can be set for the first imaging region and a second imaging condition differing from the first imaging condition can be set for the second imaging region, wherein the program causes the processor to execute: image processing based on the second imaging condition on image data outputted from the first imaging region by the imaging element capturing the subject; and compression of each of the frames subjected to the image processing on the basis of a frame differing from the frame.

Another aspect of the disclosure of a video compression program in this application is a decompression program that causes a processor to decompress a compressed file having compressed therein a plurality of frames outputted from an imaging element that has a first imaging region in which a subject is captured and a second imaging region in which a subject is captured, and in which a first imaging condition can be set for the first imaging region and a second imaging condition differing from the first imaging condition can be set for the second imaging region, wherein the program causes the processor to execute: decompression of the compressed frame within the compressed file to the frame; and image processing based on the second imaging condition and the first imaging condition for image data of a specific subject that was subjected to image processing based on the second imaging condition within the decompressed frame.

### BRIEF DESCRIPTION OF THE DRAWINGS

FIG. 1 is a cross-sectional view of a layered the imaging element.

FIG. 2 illustrates the pixel arrangement of the imaging chip.

FIG. 3 is a circuit diagram illustrating the imaging chip.

FIG. 4 is a block diagram illustrating an example of the functional configuration of the imaging element.

FIG. 5 illustrates the block configuration example of an electronic apparatus.

FIG. 6 illustrates the relation between an imaging face and a subject image.

FIG. 7 is a descriptive drawing showing one example of video compression of Embodiment 1.

FIG. 8 is a descriptive view showing a file format example for video files.

FIG. 9 is a descriptive drawing showing a decompression example of Embodiment 1.

FIG. 10 is a block diagram showing a configuration example of the control unit 502 shown in FIG. 5.

FIG. 11 is a descriptive drawing showing a search example for the specific subject by the detection unit.

FIG. 12 is a sequence diagram showing an example of operation process steps by the control unit.

FIG. 13 is a flow chart showing an example of detailed process steps of the setting process (step S1206, S1212) shown in FIG. 12.

FIG. 14 is a flow chart showing an example of detailed process steps of the specific subject detection process (step S1302) shown in FIG. 13.

FIG. 15 is a flow chart showing an example of detailed process steps of the image processing (step S1215, S1217) shown in FIG. 12.

FIG. 16 is a flowchart showing an example of detailed process steps of the playback process for the video data.

FIG. 17 is a flow chart showing an example according to Embodiment 2 of detailed process steps of the specific subject detection process (step S1302) shown in FIG. 13.

FIG. 18 is a descriptive drawing showing one example of video compression of Embodiment 3.

FIG. 19 is a descriptive drawing showing a decompression example of Embodiment 3.

FIG. 20 is a descriptive drawing showing one example of video compression of Embodiment 4.

FIG. 21 is a descriptive drawing showing a decompression example of Embodiment 4.

FIG. 22 is a descriptive drawing showing one example of video compression of Embodiment 5.

FIG. 23 is a descriptive drawing showing a decompression example of Embodiment 5.

### DETAILED DESCRIPTION OF THE EMBODIMENTS

<Configuration Example of Imaging Element>

First, the following section will describe a layered imaging element provided in an electronic apparatus. This laminated imaging element is disclosed in Japanese Patent Application No. 2012-139026, which was previously filed by the applicant of the present application. The electronic apparatus is an imaging apparatus such as a digital camera or a digital video camera.

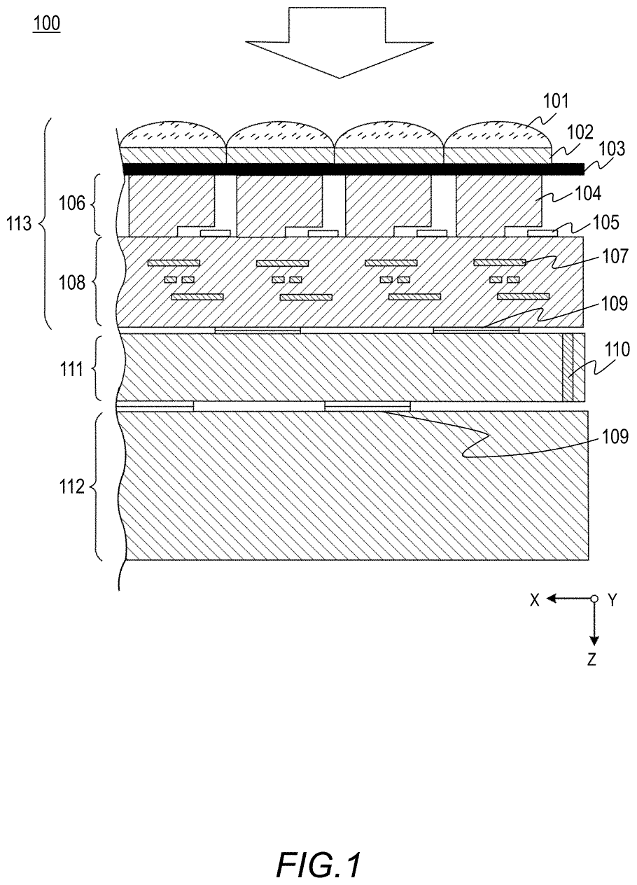

FIG. 1 is a cross-sectional view of a layered the imaging element 100. The layered imaging element (hereinafter simply referred to as “imaging element”) 100 includes a backside illumination-type imaging chip to output a pixel signal corresponding to incident light (hereinafter simply referred to as “imaging chip”) 113, a signal processing chip 111 to process a pixel signal, and a memory chip 112 to store a pixel signal. The imaging chip 113, the signal processing chip 111, and the memory chip 112 are layered and are electrically connected by a bump 109 made of conductive material such as Cu.

As shown in FIG. 1, the incident light is inputted in a positive direction in the Z axis mainly shown by the outlined arrow. In this embodiment, the imaging chip 113 is configured so that a face to which the incident light is inputted is called a back face. As shown by the coordinate axes 120, a left direction orthogonal to Z axis when viewed on the paper is a positive X axis direction and a front direction orthogonal to the Z axis and the X axis when viewed on the paper is a positive Y axis direction. In some of the subsequent drawings, the coordinate axes are shown so as to show the directions of the drawings based on the coordinate axes of FIG. 1 as a reference.

One example of the imaging chip 113 is a backside illumination-type MOS (Metal Oxide Semiconductor) image sensor. A PD (photo diode) layer 106 is provided at the back face side of a wiring layer 108. The PD layer 106 is provided in a two-dimensional manner and has a plurality of PDs 104 in which the electric charge depending on the incident light is accumulated and transistors 105 provided to correspond to the PDs 104.

The side at which the PD layer 106 receives the incident light has color filters 102 via a passivation film 103. The color filters 102 have a plurality of types to allow light to be transmitted through wavelength regions different from one another. The color filters 102 have a specific arrangement corresponding to the respective PDs 104. The arrangement of the color filters 102 will be described later. A combination of the color filter 102, the PD 104, and the transistor 105 constitutes one pixel.

A side at which the color filter 102 receives the incident light has a microlens 101 corresponding to each pixel. The microlens 101 collects the incident light toward the corresponding PD 104.

The wiring layer 108 has a wiring 107 to transmit a pixel signal from the PD layer 106 to the signal processing chip 111. The wiring 107 may have a multi-layer structure or may include a passive element and an active element.

A surface of the wiring layer 108 has thereon a plurality of bumps 109. The plurality of bumps 109 are aligned with a plurality of bumps 109 provided on an opposing face of the signal processing chip 111. The pressurization of the imaging chip 113 and the signal processing chip 111 for example causes the aligned bumps 109 to be bonded to have an electrical connection therebetween.

Similarly, the signal processing chip 111 and the memory chip 112 have therebetween faces opposed to each other that have thereon a plurality of bumps 109. These bumps 109 are mutually aligned and the pressurization of the signal processing chip 111 and the memory chip 112 for example causes the aligned bumps 109 to be bonded to have an electrical connection therebetween.

The bonding between the bumps 109 is not limited to a Cu bump bonding by the solid phase diffusion and may use a micro bump coupling by the solder melting. One bump 109 may be provided relative to one block (which will be described later) for example. Thus, the bump 109 may have a size larger than the pitch of the PD 104. Surrounding regions other than a pixel region in which pixels are arranged may additionally have a bump larger than the bump 109 corresponding to the pixel region.

The signal processing chip 111 has a TSV (silicon through-electrode) 110 to provide the mutual connection among circuits provided on the top and back faces, respectively. The TSV 110 is preferably provided in the surrounding region. The TSV 110 also may be provided in the surrounding region of the imaging chip 113 and the memory chip 112.

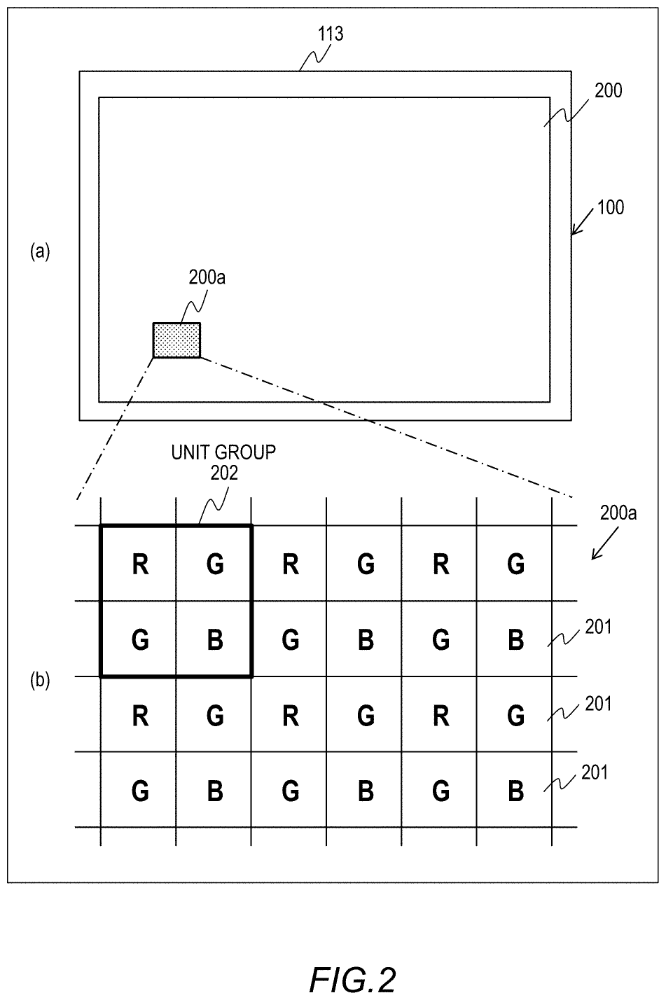

FIG. 2 illustrates the pixel arrangement of the imaging chip 113. In particular, (a) and (b) of FIG. 2 illustrate the imaging chip 113 observed from the back face side. In FIG. 2, (a) of FIG. 2 is a plan view schematically illustrating an imaging face 200 that is a back face of the imaging chip 113. In FIG. 2, (b) of FIG. 2 is an enlarged plan view illustrating a partial region 200a of the imaging face 200. As shown in (b) of FIG. 2, the imaging face 200 has many pixels 201 arranged in a two-dimensional manner.

The pixels 201 have color filter (not shown), respectively. The color filters consist of the three types of red (R), green (G), and blue (B). In (b) of FIG. 2, the reference numerals “R”, “G”, and “B” show the types of color filters owned by the pixels 201. As shown in (b) of FIG. 2, the imaging element 100 has the imaging face 200 on which the pixels 201 including the respective color filters as described above are arranged based on a so-called Bayer arrangement.

The pixel 201 having a red filter subjects red waveband light of the incident light to a photoelectric conversion to output a light reception signal (photoelectric conversion signal). Similarly, the pixel 201 having a green filter subjects green waveband light of the incident light to a photoelectric conversion to output a light reception signal. The pixel 201 having a blue filter subjects blue waveband light of the incident light to a photoelectric conversion to output a light reception signal.

The imaging element 100 is configured so that a block 202 consisting of the total of pixels 201 composed of 2 pixels×2 pixels adjacent to one another can be individually controlled. For example, when two blocks 202 different from each other simultaneously start the electric charge accumulation, then one block 202 starts the electric charge reading (i.e., the light reception signal reading) after 1/30 seconds from the start of the electric charge accumulation and the another block 202 starts the electric charge reading after 1/15 seconds from the start of the electric charge accumulation. In other words, the imaging element 100 is configured so that one imaging operation can have a different exposure time (or an electric charge accumulation time or a so-called shutter speed) for each block 202.

The imaging element 100 also can set, in addition to the above-described exposure time, an imaging signal amplification factor (a so-called ISO sensibility) that is different for each block 202. The imaging element 100 can have, for each block 202, a different timing at which the electric charge accumulation is started and/or a different timing at which the light reception signal is read. Specifically, the imaging element 100 can have a different video imaging frame rate for each block 202.

In summary, the imaging element 100 is configured so that each block 202 has different imaging conditions such as the exposure time, the amplification factor, or the frame rate. For example, a reading line (not shown) to read an imaging signal from a photoelectric conversion unit (not shown) owned by the pixel 201 is provided for each block 202 and an imaging signal can be read independently for each block 202, thereby allowing each block 202 to have a different exposure time (shutter speed).

An amplifier circuit (not shown) to amplify the imaging signal generated by the electric charge subjected to the photoelectric conversion is independently provided for each block 202. The amplification factor by the amplifier circuit can be controlled independently for each amplifier circuit, thereby allowing each block 202 to have a different signal amplification factor (ISO sensibility).

The imaging conditions that can be different for each block 202 may include, in addition to the above-described imaging conditions, the frame rate, a gain, a resolution (thinning rate), an addition line number or an addition row number to add pixel signals, the electric charge accumulation time or the accumulation number, and a digitization bit number for example. Furthermore, a control parameter may be a parameter in an image processing after an image signal is acquired from a pixel.

Regarding the imaging conditions, the brightness (diaphragm value) of each block 202 can be controlled by allowing the imaging element 100 to include a liquid crystal panel having a zone that can be independently controlled for each block 202 (one zone corresponds to one block 202) so that the liquid crystal panel is used as a light attenuation filter that can be turned ON or OFF for example.

The number of the pixels 201 constituting the block 202 is not limited to the above-described 4 (or 2×2) pixels. The block 202 may have at least one pixel 201 or may include more-than-four pixels 201.

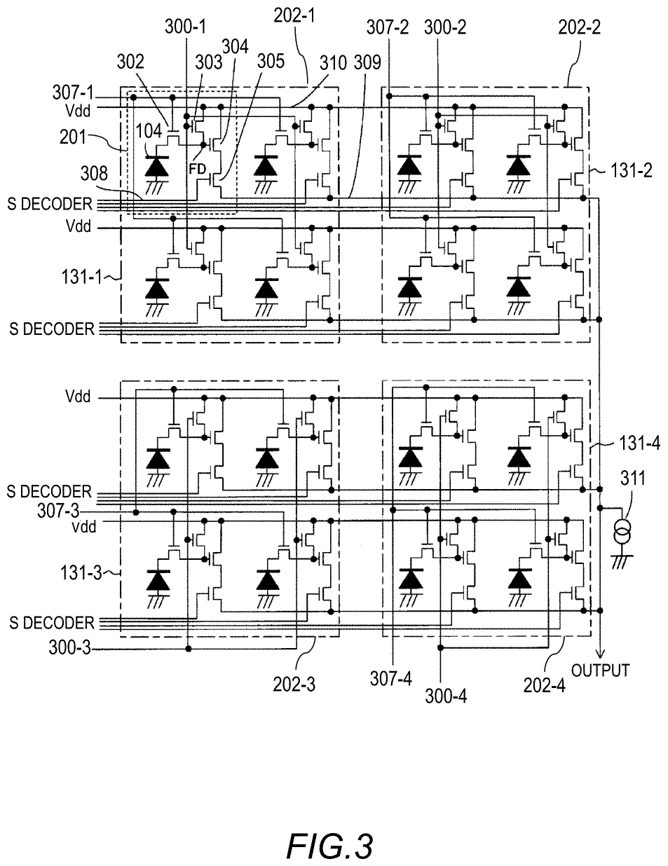

FIG. 3 is a circuit diagram illustrating the imaging chip 113. In FIG. 3, a rectangle shown by the dotted line representatively shows a circuit corresponding to one pixel 201. A rectangle shown by a dashed line corresponds to one block 202 (202-1 to 202-4). At least a part of each transistor described below corresponds to the transistor 105 of FIG. 1.

As described above, the pixel 201 has a reset transistor 303 that is turned ON or OFF by the block 202 as a unit. A transfer transistor 302 of pixel 201 is also turned ON or OFF by the block 202 as a unit. In the example shown in FIG. 3, a reset wiring 300-1 is provided that is used to turn ON or OFF the four reset transistors 303 corresponding to the upper-left block 202-1. A TX wiring 307-1 is also provided that is used to supply a transfer pulse to the four transfer transistors 302 corresponding to the block 202-1.

Similarly, a reset wiring 300-3 is provided that is used to turn ON of OFF the four reset transistors 303 corresponding to the lower-left the block 202-3 so that the reset wiring 300-3 is provided separately from the reset wiring 300-1. A TX wiring 307-3 is provided that is used to supply a transfer pulse to the four transfer transistors 302 corresponding to the block 202-3 so that the TX wiring 307-3 is provided separately from the TX wiring 307-1.

An upper-right block 202-2 and a lower-right block 202-4 similarly have a reset wiring 300-2 and a TX wiring 307-2 as well as a reset wiring 300-4 and a TX wiring 307-4 that are provided in the respective blocks 202.

The 16 PDs 104 corresponding to each pixel 201 are connected to the corresponding transfer transistors 302, respectively. The gate of each transfer transistor 302 receives a transfer pulse supplied via the TX wiring of each block 202. The drain of each transfer transistor 302 is connected to the source of the corresponding reset transistor 303. A so-called floating diffusion FD between the drain of the transfer transistor 302 and the source of the reset transistor 303 is connected to the gate of the corresponding amplification transistor 304.

The drain of each reset transistor 303 is commonly connected to a Vdd wiring 310 to which a supply voltage is supplied. The gate of each reset transistor 303 receives a reset pulse supplied via the reset wiring of each block 202.

The drain of each amplification transistor 304 is commonly connected to the Vdd wiring 310 to which a supply voltage is supplied. The source of each amplification transistor 304 is connected to the drain of the corresponding the selection transistor 305. The gate of each the selection transistor 305 is connected to a decoder wiring 308 to which a selection pulse is supplied. The decoder wirings 308 are provided independently for 16 selection transistors 305, respectively.

The source of each selection transistor 305 is connected to a common output wiring 309. A load current source 311 supplies a current to an output wiring 309. Specifically, the output wiring 309 to the selection transistor 305 is formed by a source follower. It is noted that the load current source 311 may be provided at the imaging chip 113 side or may be provided at the signal processing chip 111 side.

The following section will describe the flow from the start of the accumulation of the electric charge to the pixel output after the completion of the accumulation. A reset pulse is applied to the reset transistor 303 through the reset wiring of each block 202 and a transfer pulse is simultaneously applied the transfer transistor 302 through the TX wiring of each block 202 (202-1 to 202-4). Then, the PD 104 and a potential of the floating diffusion FD are reset for each block 202.

When the application of the transfer pulse is cancelled, each PD 104 converts the received incident light to electric charge to accumulate the electric charge. Thereafter, when a transfer pulse is applied again while no reset pulse is being applied, the accumulated electric charge is transferred to the floating diffusion FD. The potential of the floating diffusion FD is used as a signal potential after the accumulation of the electric charge from the reset potential.

Then, when a selection pulse is applied to the selection transistor 305 through the decoder wiring 308, a variation of the signal potential of the floating diffusion FD is transmitted to the output wiring 309 via the amplification transistor 304 and the selection transistor 305. This allows the pixel signal corresponding to the reset potential and the signal potential to be outputted from the unit pixel to the output wiring 309.

As described above, the four pixels forming the block 202 have common reset wiring and TX wiring. Specifically, the reset pulse and the transfer pulse are simultaneously applied to the four pixels within the block 202, respectively. Thus, all pixels 201 forming a certain block 202 start the electric charge accumulation at the same timing and complete the electric charge accumulation at the same timing. However, a pixel signal corresponding to the accumulated electric charge is selectively outputted from the output wiring 309 by sequentially applying the selection pulse to the respective selection transistors 305.

In this manner, the timing at which the electric charge accumulation is started can be controlled for each block 202. In other words, images can be formed at different timings among different blocks 202.

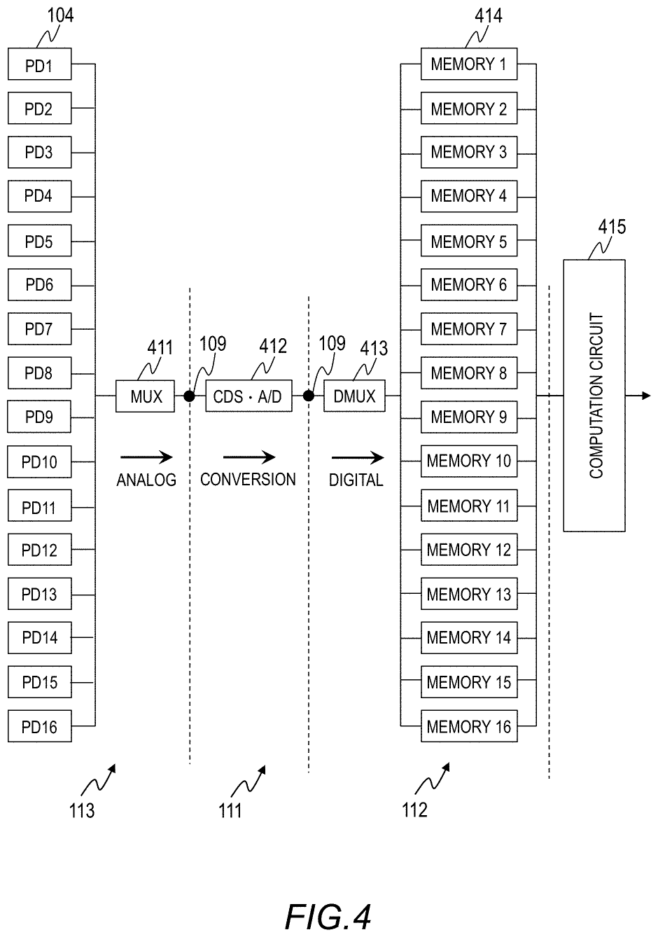

FIG. 4 is a block diagram illustrating an example of the functional configuration of the imaging element 100. An analog multiplexer 411 sequentially selects the sixteen PDs 104 forming the block 202 to output the respective pixel signals to the output wiring 309 provided to correspond to the block 202. The multiplexer 411 is formed in the imaging chip 113 together with the PDs 104.

The pixel signal outputted via the multiplexer 411 is subjected to the correlated double sampling (CDS) and the analog/digital (A/D) conversion performed by the signal processing circuit 412 formed in the signal processing chip 111. The A/D-converted pixel signal is sent to a demultiplexer 413 and is stored in a pixel memory 414 corresponding to the respective pixels. The demultiplexer 413 and the pixel memory 414 are formed in the memory chip 112.

A computation circuit 415 processes the pixel signal stored in the pixel memory 414 to send the result to the subsequent image processing unit. The computation circuit 415 may be provided in the signal processing chip 111 or may be provided in the memory chip 112. It is noted that FIG. 4 shows the connection of the four blocks 202 but they actually exist for each of the four blocks 202 and operate in a parallel manner.

However, the computation circuit 415 does not have to exist for each of the four blocks 202. For example, one computation circuit 415 may provide a sequential processing while sequentially referring to the values of the pixel memories 414 corresponding to the respective four blocks 202.

As described above, the output wirings 309 are provided to correspond to the respective blocks 202. The imaging element 100 is configured by layering the imaging chip 113, the signal processing chip 111, and the memory chip 112. Thus, these output wirings 309 can use the electrical connection among chips using the bump 109 to thereby providing a wiring arrangement without causing an increase of the respective chips in the face direction.

<Block Configuration Example of Electronic Apparatus>

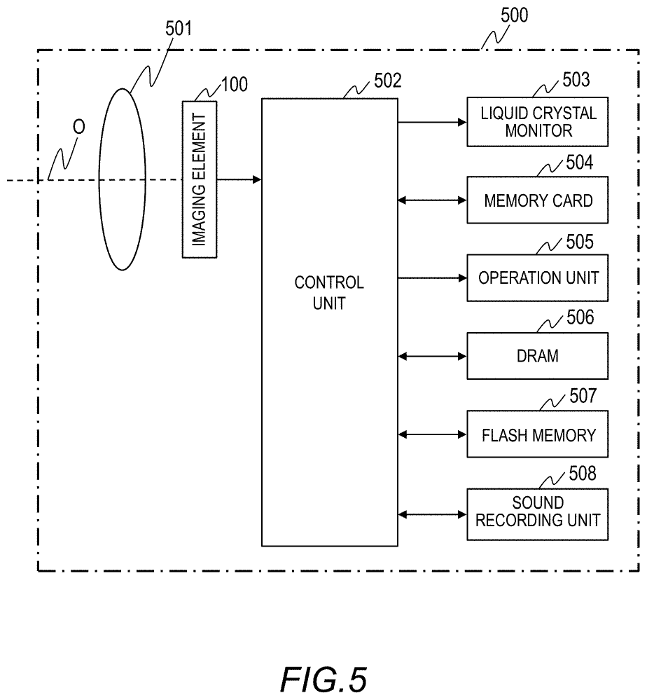

FIG. 5 illustrates the block configuration example of an electronic apparatus. An electronic apparatus 500 is a lens integrated-type camera for example. The electronic apparatus 500 includes an imaging optical system 501, an imaging element 100, a control unit 502, a liquid crystal monitor 503, a memory card 504, an operation unit 505, a DRAM 506, a flash memory 507, and a sound recording unit 508. The control unit 502 includes a compression unit for compressing video data as described later. Thus, a configuration in the electronic apparatus 500 that includes at least the control unit 502 functions as a video compression apparatus, a decompression apparatus or a playback apparatus. Furthermore, a memory card 504, a DRAM 506, and a flash memory 507 constitute a storage device 1202 described later.

The imaging optical system 501 is composed of a plurality of lenses and allows the imaging face 200 of the imaging element 100 to form a subject image. It is noted that FIG. 5 shows the imaging optical system 501 as one lens for convenience.

The imaging element 100 is an imaging element such as a CMOS (Complementary Metal Oxide Semiconductor) or a CCD (Charge Coupled Device) and images a subject image formed by the imaging optical system 501 to output an imaging signal. The control unit 502 is an electronic circuit to control the respective units of the electronic apparatus 500 and is composed of a processor and a surrounding circuit thereof.

The flash memory 507, which is a nonvolatile storage medium, includes a predetermined control program written therein in advance. A processor in the control unit 502 reads the control program from the flash memory 507 to execute the control program to thereby control the respective units. This control program uses, as a work area, the DRAM 506 functioning as a volatile storage medium.

The liquid crystal monitor 503 is a display apparatus using a liquid crystal panel. The control unit 502 allows, at a predetermined cycle (e.g., 60/1 seconds), the imaging element 100 to form a subject image repeatedly. Then, the imaging signal outputted from the imaging element 100 is subjected to various image processings to prepare a so-called through image to display the through image on the liquid crystal monitor 503. The liquid crystal monitor 503 displays, in addition to the above through image, a screen used to set imaging conditions for example.

The control unit 502 prepares, based on the imaging signal outputted from the imaging element 100, an image file (which will be described later) to record the image file on the memory card 504 functioning as a portable recording medium. The operation unit 505 has various operation units such as a push button. The operation unit 505 outputs, depending on the operation of these operation members, an operation signal to the control unit 502.

The sound recording unit 508 is composed of a microphone for example and converts the environmental sound to an acoustic signal to input the resultant signal to the control unit 502. It is noted that the control unit 502 may record a video file not in the memory card 504 functioning as a portable recording medium but in a recording medium (not shown) included in the electronic apparatus 500 such as a hard disk or a solid state drive (SSD).

<Relation Between the Imaging Face and the Subject Image>

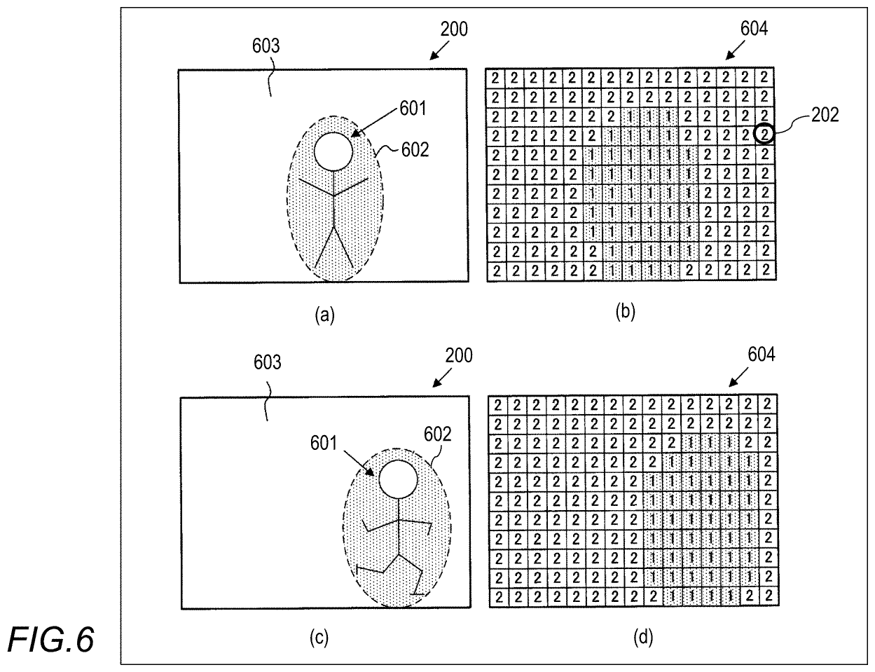

FIG. 6 illustrates the relation between an imaging face and a subject image. In FIG. 6, (a) of FIG. 6 is a schematic view illustrating the imaging face 200 (imaging range) of the imaging element 100 and a subject image 601. In (a) of FIG. 6, the control unit 502 images the subject image 601. The imaging operation of (a) of FIG. 6 also may be used as an imaging operation performed to prepare a live view image (a so-called through image).

The control unit 502 subjects the subject image 601 obtained by the imaging operation of (a) of FIG. 6 to a predetermined image analysis processing. The image analysis processing is a processing to use a well-known subject detection technique (a technique to compute a feature quantity to detect a range in which a predetermined subject exists) for example to detect a main subject region. In the first embodiment, a region other than a main subject is a background. A main subject is detected by the image analysis processing, which causes the imaging face 200 to be divided to a main subject region 602 including a main subject and a background region 603 including the background.

It is noted that (a) of FIG. 6 shows that a region approximately including the subject image 601 is shown as the main subject region 602. However, the main subject region 602 may have a shape formed along the external form of the subject image 601. Specifically, the main subject region 602 may be set so as not to include images other than the subject image 601.

The control unit 502 sets different imaging conditions for each block 202 in the main subject region 602 and each block 202 in the background region 603. For example, a precedent block 202 is set to have a higher shutter speed than that of a subsequent block 202. This suppresses, in the imaging operation of (c) of FIG. 6 after the imaging operation of (a) of FIG. 6, the main subject region 602 from having image blur.

The control unit 502 is configured, when the influence by a light source such as sun existing in the background region 603 causes the main subject region 602 to have a backlight status, to set the block 202 of the former to have a relatively-high ISO sensibility or a lower shutter speed. The control unit 502 is also configured to set the block 202 of the latter to have a relatively-low ISO sensibility or a higher shutter speed. This can prevent, in the imaging operation of (c) of FIG. 6, the black defect of the main subject region 602 in the backlight status and the blown out highlights of the background region 603 having a high light quantity.

It is noted that the image analysis processing may be a processing different from the above-described processing to detect the main subject region 602 and the background region 603. For example, this processing may be a processing to detect a part of the entire imaging face 200 that has a brightness equal to or higher than a certain value (a part having an excessively-high brightness) or that has a brightness lower than the than a certain value (a part having an excessively-low brightness). When the image analysis processing is such a processing, the control unit 502 may set the shutter speed and/or the ISO sensibility so that the block 202 included in the former region has an exposure value (Ev value) lower than that of the block 202 included in another region.

The control unit 502 sets the shutter speed and/or the ISO sensibility so that the block 202 included in the latter region has an exposure value (Ev value) higher than that of the block 202 included in another region. This can consequently allow an image obtained through the imaging operation of (c) of FIG. 6 to have a dynamic range wider than the original dynamic range of the imaging element 100.

In FIG. 6, (b) of FIG. 6 shows one example of mask information 604 corresponding to the imaging face 200 shown in (a) of FIG. 6. The position of the block 202 belonging to the main subject region 602 stores therein “1” and the position of the block 202 belonging to the background region 603 stores therein “2”, respectively.

The control unit 502 subjects the image data of the first frame to the image analysis processing to detect the main subject region 602 and the background region 603. In this document, the frame resulting from the imaging performed in (a) is divided into a primary subject region 602 and a background region 603 that is a region that is not the main subject region 602, as shown in (b). The control unit 502 sets different imaging conditions for each block 202 in the main subject region 602 and each block 202 in the background region 603 to perform the imaging operation of (c) of FIG. 6 to prepare image data. An example of the resultant mask information 604 is shown in (d) of FIG. 6.

The mask information 604 of (b) of FIG. 6 corresponding to the imaging result of (a) of FIG. 6 and the mask information 604 of (d) of FIG. 6 corresponding to the imaging result of (c) of FIG. 6 are obtained by the imaging operations performed at different times (or have a time difference). Thus, these two pieces of the mask information 604 have different contents when the subject has moved or the user has moved the electronic apparatus 500. In other words, the mask information 604 is dynamic information changing with the time passage. Thus, a certain block 202 has different imaging conditions set for the respective frames.

Below, embodiments of compression, decompression, and playback of a video using the imaging element 100 will be described. Conventionally, even if differing imaging conditions (such as the ISO speed) were set for each of a plurality of imaging regions set in the imaging surface 200 of the imaging element 100, a configuration in which image processing (correction) is executed to change the ISO speed of the imaging regions after imaging has not been considered. Thus, the block matching accuracy when performing video compression decreases. With these embodiments, even after imaging has been completed, it is possible to execute image processing that yields an image that has the appearance of having been captured under differing desired imaging conditions. As a result, the block matching accuracy when performing video compression can be increased.

### Embodiment 1

<Video Compression Example>

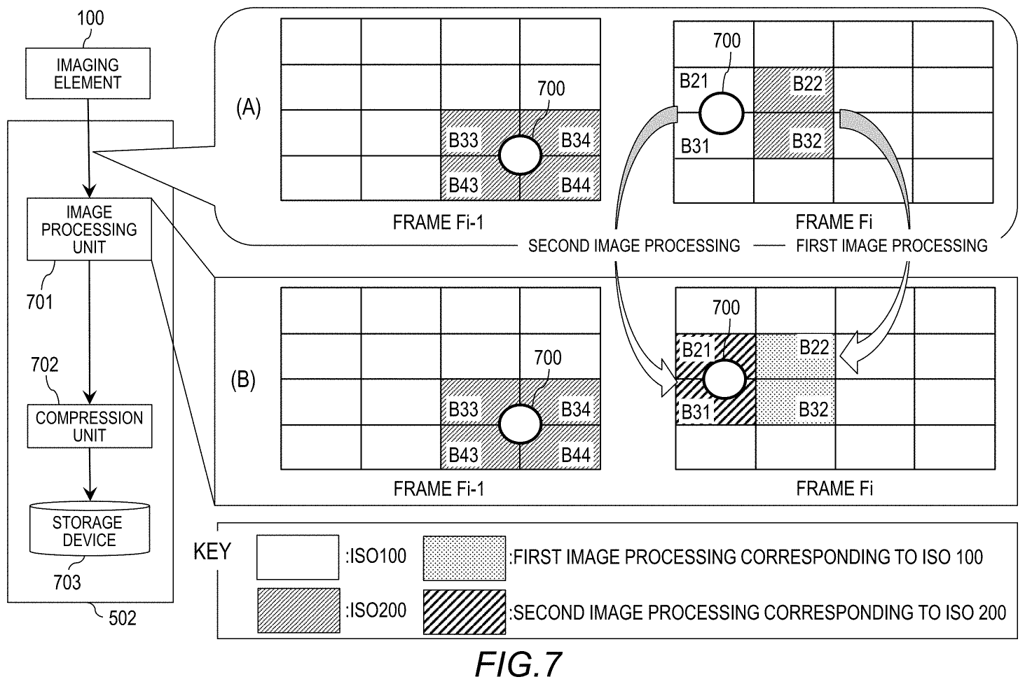

FIG. 7 is a descriptive drawing showing one example of video compression of Embodiment 1. The electronic apparatus 500 has the imaging element 100 and the control unit 502. The control unit 502 includes an image processing unit 701 and a compression unit 702. As described above, the imaging element 100 has a plurality of imaging regions in which a subject is captured. Each of the imaging regions is a group of pixels including at least one pixel, and is the one or more blocks 202 described above, for example. Below, an example is described in which the ISO speed is set for each block 202 in the imaging regions.

Here, among the imaging regions, a first imaging region has set therefor a first imaging condition (ISO speed 100, for example), and a second imaging region differing from the first imaging region has set therefor a second imaging condition having a differing value from the first imaging condition (ISO speed 200, for example). The values for the first imaging condition and the second imaging condition are merely one example. The ISO speed for the second imaging condition may be higher or lower than the ISO speed for the first imaging condition.

The imaging element 100 captures the subject and outputs an image signal to the image processing unit 701 as a series of frames. In FIG. 7, consecutive frames in the time direction are labeled Fi−1, Fi (i being an integer 2). The frame Fi−1 is the frame preceding the frame Fi. The subsequent frame to the frame Fi is referred to as the frame Fi+1. The frame preceding the frame Fi−1 is referred to as the frame Fi−2. If not distinguishing between frames, the frames are referred to as the frame F. In the frame F, the region of the image data generated by being captured in the imaging region where the imaging element 100 is present is referred to as an “image region.”

In this example, the entire imaging region of the imaging element 100 is set as the first imaging region, or in other words, set to the first imaging condition (ISO speed 100). Also, within the first imaging region, the imaging region where the subject is present or likely to be present is the second imaging region, as is set to the second imaging condition (ISO speed 200). The region of the image data outputted by imaging in the first imaging region is set as a first image region, and the region of the image data outputted by imaging in the second imaging region is set as a second image region.

The image regions are a plurality of regions corresponding to the imaging regions of the imaging element 100, for example. In FIG. 7, the frame F is constituted of 4×4 image regions, for example. Each image region is constituted of a group of one or more pixels, and corresponds to one or more blocks 202 (imaging regions). The image region corresponding to the first imaging region is referred to as the first image region, and the image region corresponding to the second imaging region is referred to as the second image region. Therefore, the first image region includes image data generated by imaging under the first imaging condition (ISO speed 100) and the second image region includes image data generated by imaging under the second imaging condition (ISO speed 200).

Also, the frame F includes a specific subject 700 that is not the background. In (A), as a result of subject detection, the 2×2 image regions B33, B34, B43, and B44 at the lower right of the frame Fi−1 where the subject is present are the second image regions corresponding to the second imaging regions for which the second imaging condition (ISO speed 200) is set.

Also, the two image regions B22 and B32, which are arranged vertically at the center left section of the frame Fi where the specific subject 700 is present, are the second image regions corresponding to the second imaging regions for which the second imaging condition (ISO speed 200) is set by predicting the position of the specific subject 700 between the immediately preceding frame Fi−1 and the frame Fi−2 (not shown). As a result of predicting the position of the specific subject 700, the second imaging region and the corresponding second image region are predicted. In a hypothetical scenario, the actual specific subject 700 ends up being located in the image regions B21 and B22 in the center of the left edge as a result of the prediction of the position as being in the second image regions B22 and B32 being off.

The image processing unit 701 executes image processing corresponding to the second imaging condition (ISO speed 200) (hereinafter, referred to as “second image processing”) for image data in the image regions where the specific subject 700 captured under the first imaging condition (ISO speed 100) is present. Specifically, the image processing unit 701 executes the second image processing for image data of the first image regions B21 and B31 where the specific subject 700 of the frame Fi is present, for example. The second image processing is image processing for correcting the image data of the first image region captured under the first imaging condition (ISO speed 100) such that the image data has the appearance of having been captured under the second imaging condition.

In other words, in the second image processing, if correcting the image data after imaging such that the ISO speed for imaging appears to be 2^{N} times (N being an integer of 1 or greater) the original ISO speed, the exposure of the image data is corrected to +(1.0×N) EV. In Embodiment 1, the image data attained under an ISO speed of 100 is to be corrected such that the image data appears to have been captured under an ISO speed of 200 (that is, N=1), and thus, the image processing unit 701 executes second image processing (+1.0EV) for raising the exposure of the first image regions B21 and B31 by one level. The image processing unit 701 performs the correction on the basis of the difference in imaging conditions set in this manner. Specifically, the image processing unit 700 performs the correction on the basis of the difference in setting values for the imaging conditions (ISO speeds 100, 200, for example), for example.

Also, the image processing unit 701 executes image processing corresponding to the first imaging condition (ISO speed 100) (hereinafter, referred to as “first image processing”) for image data in the image regions where the specific subject 700 captured under the second imaging condition (ISO speed 200) is no longer present. The first image processing is image processing for correcting the image data of the second image region captured under the second imaging condition (ISO speed 200) such that the image data has the appearance of having been captured under the first imaging condition.

In other words, in the first image processing, if correcting the image data after imaging such that the ISO speed for imaging appears to be 2^{-N} times the original ISO speed, the exposure of the image data is corrected to −(1.0×N) EV. In Embodiment 1, the image data attained under an ISO speed of 200 is to be corrected such that the image data appears to have been captured under an ISO speed of 100 (that is, N=1), and thus, the image processing unit 701 executes first image processing (−1.0EV) for lowering the exposure of the second image regions B22 and B32 by one level.

The compression unit 702 performs hybrid encoding in which entropy encoding is combined with motion compensation (MC) interframe coding and discrete cosign transform (DCT) to employ block matching to compress the frames F outputted from the image processing unit 701.

As a result, the image regions in which the specific subject 700 is present are the first image regions (B21, B31) subjected to second image processing, and thus, the specific subject 700 is at an equivalent brightness across frames. Thus, it is possible to increase block matching accuracy among the frames Fi−1 and Fi. Also, image regions captured under the second imaging condition (ISO speed 200) despite the specific subject 700 not being present therein are subjected to the first image processing, and thus, the image regions are at an equivalent brightness across frames. Thus, it is possible to increase block matching accuracy among the frames Fi−1 and Fi. The frames F compressed by the compression unit 702 (hereinafter, compressed frames F) are stored in the storage device 703 as compressed files.

<File Format Example for Video Files>

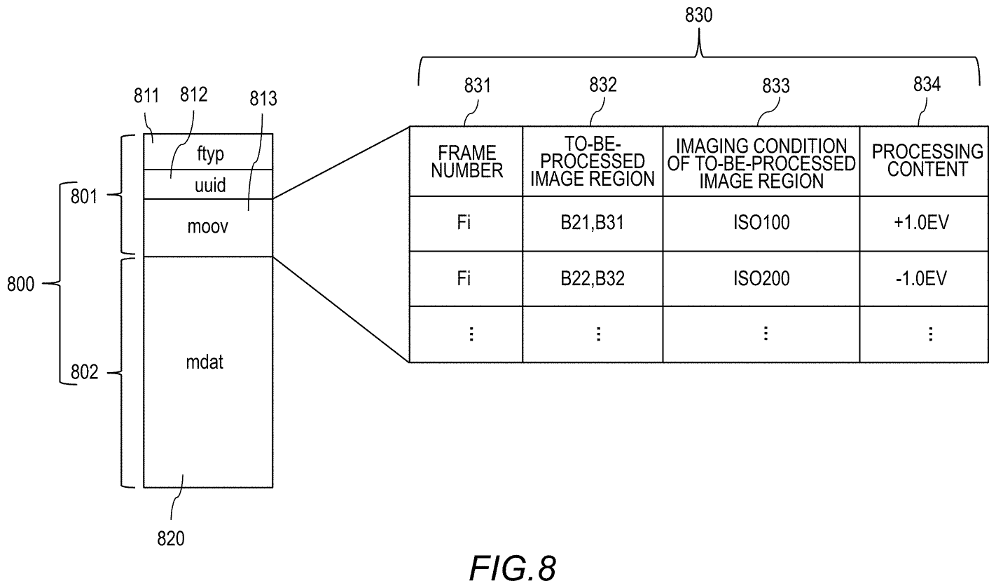

FIG. 8 is a descriptive view showing a file format example for video files. In FIG. 8, an example is shown in which a file format that conforms to MPEG-4 (Moving Picture Experts Group-phase 4) is used.

A compressed file 800 is a collection of data referred to as boxes, and has a header portion 801 and a data portion 802. The header portion 801 includes, as boxes, an ftyp 811, a uuid 812, and a moov 813. The data portion 802 includes, as a box, an mdat 820.

The ftyp 811 is a box that stores information indicating the type of compressed file 800, and is disposed at a position in front of other boxes in the compressed file 800. The uuid 812 is a box that stores a general purpose unique identifier, and is expandable by the user.

The moov 813 is a box that stores metadata pertaining to various types of media such as video, audio, or text. The mdat 820 is a box that stores of data of the various types of media such as video, audio, or text. The moov 813 has the uuid, the udta, the mvhd, and the trak, but here, the explanation will focus on the stored data of Embodiment 1.

Next, the boxes in the moov 813 will be explained in detail. The moov 813 stores image processing information 830. The image processing information 830 is information in which a frame number 831, a to-be-processed image region 832, an imaging condition 833 of the to-be-processed image region, and processing content 834 are associated with each other. The frame number 831 is identification information that uniquely identifies the frame F. In FIG. 8, for ease of explanation, the number Fi for the frame is used as the frame number 831.

The to-be-processed image region 832 is identification information that identifies the image region to be processed by the image processing unit 701. The imaging condition 833 of the to-be-processed image region is an imaging condition set for the imaging region that is the output source for the to-be-processed image region 832. The processing content 834 is image processing content set for the to-be-processed image region 832.

The first row entry of the image processing information 830 indicates the first image regions in which the image regions B21 and B31 of the frame Fi were imaged under an ISO speed of 100, and indicates that the second image processing was performed thereon to raise the exposure by one level to achieve an image with +1.0EV. The second row entry of the image processing information 830 indicates the second image regions in which the image regions B22 and B32 of the frame Fi were imaged under an ISO speed of 200, and indicates that the first image processing was performed thereon to lower the exposure by one level to achieve an image with −1.0EV.

The mdat 820 is a box that stores chunks for each media (video, audio, text). Each chunk is constituted of a plurality of samples. If the type of media is video, then the one sample is one compressed frame.

<Decompression Example>

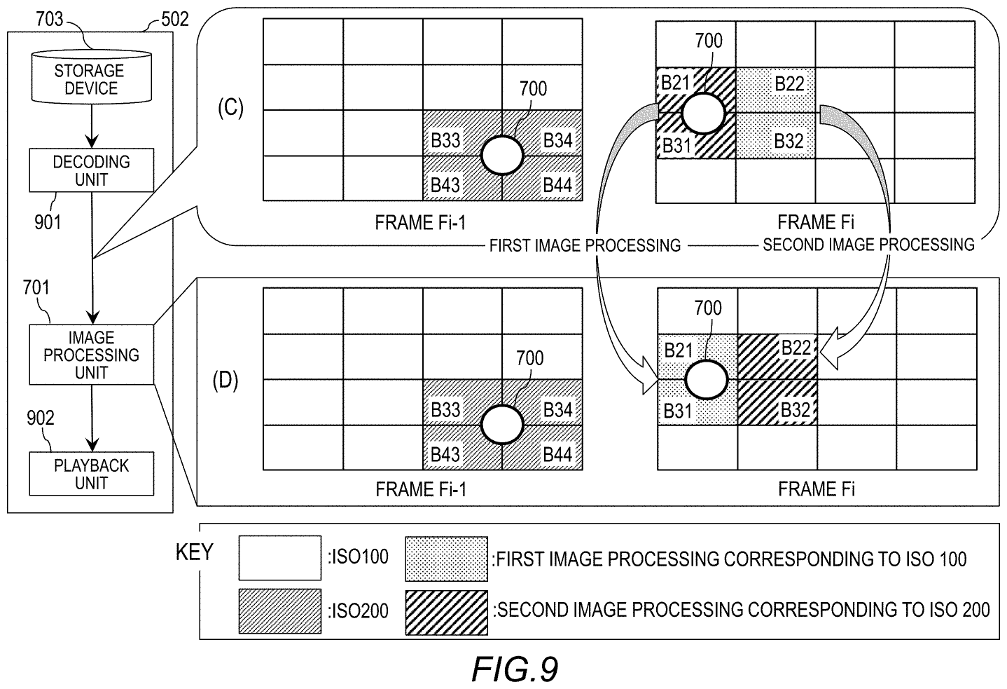

FIG. 9 is a descriptive drawing showing a decompression example of Embodiment 1. The control unit 502 of the electronic apparatus 500 includes a decompression unit 901, the image processing unit 701, and a playback unit 902. The decompression unit 901 decompresses the compressed file 800 stored in the storage device 703 and outputs the series of frames F to the image processing unit 701. The image processing unit 701 decodes the image regions that were corrected by the image processing shown in FIG. 7 and then outputs the series of frames F to the playback unit 902. The playback unit 902 plays back the series of frames F from the image processing unit 701.

(C) shows the decompressed frames Fi−1 and Fi. The decompressed frames Fi−1 and Fi are the same as the frames Fi−1 and Fi after the image processing of (B) in FIG. 7. (D) shows an image processing example for the decompressed frame Fi. The image processing unit 701 refers to the image processing information 830 shown in FIG. 8 to execute the first image processing or the second image processing.

When the to-be-processed image regions 832 shown in FIG. 8 are “B21, B31,” the second image processing of “+1.0EV” is performed as the processing content 834. Thus, the image processing unit 701 executes first image processing (−1.0EV) for lowering the exposure of the image data of the image regions B21 and B31 by one level.

Also, when the to-be-processed image regions 832 are “B22, B32,” the first image processing of “−1.0EV” is performed as the processing content 834. Thus, the image processing unit 701 executes second image processing (+1.0EV) for raising the exposure of the image regions B22 and B32 by one level. As a result, it is possible to decode the frame F subjected to image processing to the original state, and it is possible to improve reproducibility of the original frame F. In the description above, an example was described of performing image processing of restoring to the original state the sections subjected to image processing (correction) when performing compression, but typically, the image regions where the specific subject 700 is present are regions captured under an ISO speed of 200, and thus, the first image processing need not be performed. Which image processing to perform may be selected by a user.

<Configuration Example of Control Unit 502>

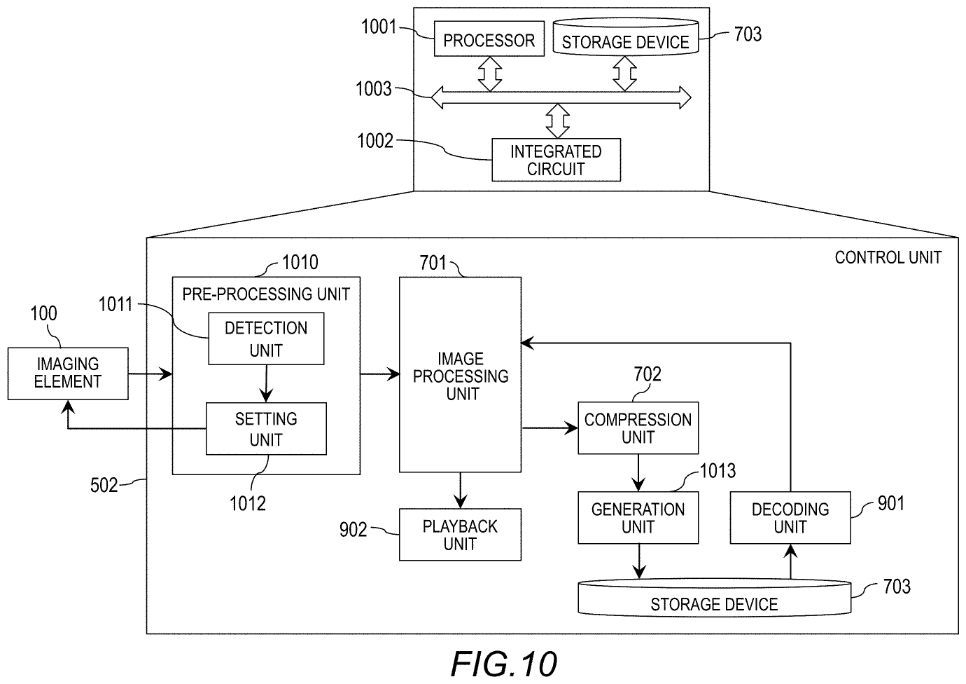

FIG. 10 is a block diagram showing a configuration example of the control unit 502 shown in FIG. 5. The control unit 502 has a pre-processing unit 1010, the image processing unit 701, the compression unit 702, a generation unit 1013, the decompression unit 901, and the playback unit 902, and is constituted of a processor 1001, the storage device 703, an integrated circuit 1002, and a bus 1003 that connects the foregoing components. The storage device 703, the decompression unit 901, and the playback unit 902 may be installed in another apparatus that can access the electronic apparatus 500.

The pre-processing unit 1010, the image processing unit 701, the compression unit 702, the generation unit 1013, the decompression unit 901, and the playback unit 902 may be realized by programs stored in the storage device 703 being executed by the processor 1001, or by an integrated circuit 1002 such as an ASIC (application-specific integrated circuit) or an FPGA (field-programmable gate array). Also, the processor 1001 may use the storage device 703 as a work area. Additionally, the integrated circuit 1002 may use the storage device 703 as a buffer in which to temporarily store various data including the image data.

An apparatus that includes at least the compression unit 702 is a video compression apparatus. Also, an apparatus that includes at least the decompression unit 901 is a decompression apparatus. Additionally, an apparatus that includes at least the playback unit 902 is a playback apparatus.

The pre-processing unit 1010 executes pre-processing for generating the compressed file 800 for the series of frames F from the imaging element 100. Specifically, for example, the pre-processing unit 1010 has a detection unit 1011 and a setting unit 1012. The detection unit 1011 detects the specific subject 700 through the above-mentioned well-known subject detection technique. The detection unit 1011 predicts the position of the specific subject 700 in the subsequent frame, that is, the second imaging region where the specific subject 700 is likely to be present in the subsequent frame on the basis of the detection results for the specific subject 700. By the second imaging region being predicted, the corresponding second image region is also predicted. Also, the detection unit 1011 uses the well-known template matching technique to continuously detect (track) the specific subject 700, for example.

If, within the imaging surface 200 of the imaging element 100, the image region where the specific subject 700 is detected is the first image region, then the setting unit 1012 switches the imaging conditions of the first imaging region corresponding to the first image region to the second imaging condition (ISO speed 200) from the first imaging condition (ISO speed 100). As a result, the first imaging region corresponding to the first image region where the specific subject 700 was detected becomes the second imaging region.

Specifically, for example, the detection unit 1011 detects the motion vector of the specific subject according to the difference between the specific subject 700 detected in the input frame Fi and the specific subject 700 detected in the previous frame Fi−1, and predicts the image region of the specific subject 700 in the subsequent input frame Fi+1. The setting unit 1012 changes the imaging region corresponding to the predicted image region to the second imaging condition. The setting unit 1012 identifies and outputs, to the image processing unit 701 as additional information, the image region where the specific subject 700 is present in each frame Fi, and information indicating the first image region set to the first imaging condition (ISO speed 100) and the second image region set to the second imaging condition (ISO speed 200).

The image processing unit 701 executes the second image processing as shown in FIG. 7 prior to compression of the frame F, and embeds the image processing information 830 in the moov 813. After decompression of the compressed frame F, the image processing unit 701 uses the image processing information 830 embedded in the decompressed frame F to execute the first image processing as shown in FIG. 9.

The compression unit 702 performs hybrid encoding in which entropy encoding is combined with motion compensation (MC) interframe coding and discrete cosign transform (DCT) to employ block matching to compress the frames F outputted from the image processing unit 701. As a result, the image regions in which the specific subject 700 is present are the second image regions or the first image regions subjected to second image processing, and thus, the specific subject 700 is at an equivalent brightness across the frames F. Therefore, it is possible to increase block matching accuracy by the compression unit 702.

The generation unit 1013 generates the compressed file 800 including the compressed frame F that was compressed by the compression unit 702. Specifically, for example, the generation unit 1013 generates the compressed file 800 according to the file format shown in FIG. 8. The generation unit 1013 stores the generated compressed file 800 in the storage device 703.

The decompression unit 901 reads the compressed file 800 in storage device 703 and decompresses the compressed file according to the file format. That is, the decompression unit 901 executes a general use decompression process. Specifically, for example, the decompression unit 901 executes a variable length decoding process, inverse quantization, and inverse conversion on the compressed frame F in the compressed file 800, and decompresses the compressed frame F to the original frame F.

The decompression unit 901 outputs the decompressed frame F to the image processing unit 701. The decompression unit 901 decompresses not only the frames F but also performs similar decompression on audio chunk samples and text chunk samples. The playback unit 902 plays back video data including the series of frames F, audio, and text, which are outputted from the image processing unit 701.

<Subject Image Search Example>

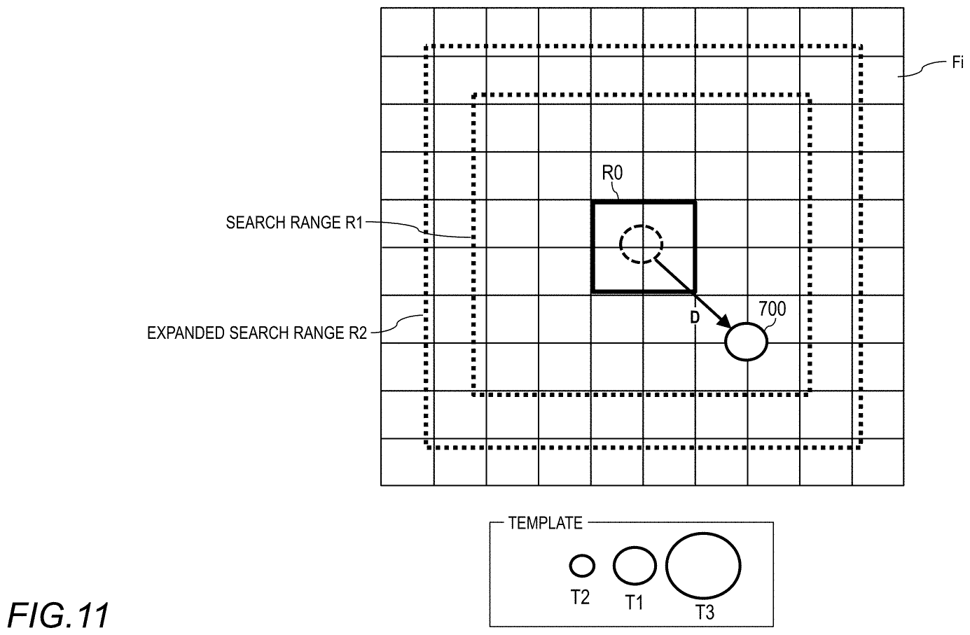

FIG. 11 is a descriptive drawing showing a search example for the specific subject by the detection unit 1011. Here, an example in which the specific subject is continuously detected (tracked) is described as an example of the detection performed by the detection unit 1011. In FIG. 11, the reference character R0 refers to an image region group in which the specific subject 700 was detected in the previous frame Fi−1. The dotted circle indicates the specific subject 700 in the previous frame Fi−1. The detection unit 1011 sets a search range R1 centered on the region R0 and uses a template T1 to execute template matching.

In Embodiment 1, there are a plurality of templates T1 to T3 of differing sizes, where T2 is the smallest and T3 is the largest. The templates T1 to T3 may be stored in advance in the storage device 703, and the detection unit 1011 may extract the specific subject 700 from the previous frame Fi−1 to generate the templates T1 to T3.

The detection unit 1011 detects the region with the smallest difference from the template T1 as the specific subject 700. However, if the specific subject 700 in which the difference from the template T1 is within an allowable range is present in the search range R1, the detection results for the specific subject 700 have a high degree of reliability, and thus, the detection unit 1011 is considered to have detected the specific subject 700.

If the specific subject 700 in which the difference from the template T1 is within an allowable range is not present in the search range R1, the detection results have a low degree of reliability. Thus, the detection unit 1011 expands the search range R1 to set a search range R2. The detection unit 1011 attempts template matching in the search range R2. If the specific subject 700 in which the difference from the template T1 is within an allowable range is present in the search range R2, then the detection unit 1011 is considered to have detected the specific subject 700.

In this manner, the detection unit 1011 expands the search range in stages to detect the specific subject 700. Also, if the specific subject 700 is not detected within the search range R1 or R2, then the detection unit 1011 attempts template matching by changing the template from T1 to T2 and T3. As a result, the specific subject 700 is detected while taking into consideration movement of the specific subject in the depth direction.

Template matching while changing the template from T1 to T2 and T3 may be performed in parallel. Specifically, template matching may be performed such that the template is selected in the order of T2→T1→T3 in the search range R1, and if the specific subject 700 is not detected, the template is selected in the order of T2→T1→T3 in the search range R2. Also, switching from the template T1, selecting both T2 and T3, and simultaneously performing template matching for the templates T2 and T3 may be executed.

A configuration may be adopted in which, if a distance D between the region R0 and the specific subject 700 detected in the subject detection process is greater than or equal to a prescribed distance, then this is considered a failed search, where the specific subject 700 was not detected within the search range. If the specific subject 700 is not detected with the template T1, then an attempt may be skipped for the other templates T2 and T3.

Also, the detection unit 1011 may expand the search range as much as possible and perform template matching therein. Additionally, the detection unit 1011 executes template matching using a plurality of templates. As a result, it is possible to detect the specific subject 700 present in the first image regions (B21, B31 in (A) of FIG. 7) outside of the predicted second image regions (B22, B32 in (A) of FIG. 7). In other words, if the prediction of the second image regions is correct, then the second imaging regions are set dynamically in the imaging element 100, and thus, the specific subject 700 is present in the second image regions (B22, B32 in (A) of FIG. 7) corresponding to the dynamically set second imaging regions.

<Example of Operation Process Steps of Control Unit 502>

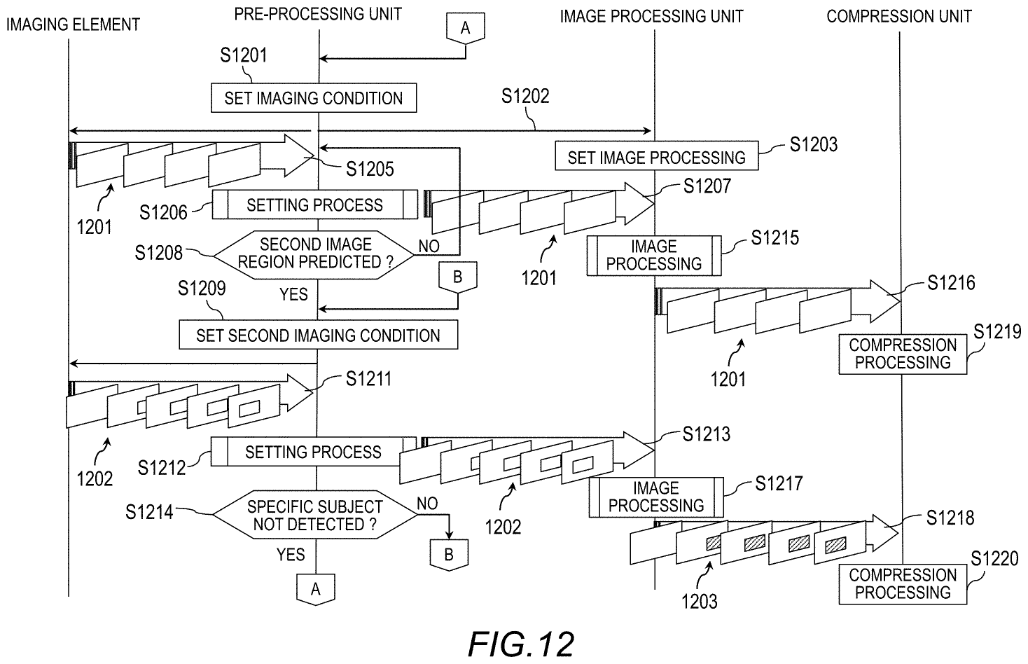

FIG. 12 is a sequence diagram showing an example of operation process steps by the control unit 502. The pre-processing unit 1010 sets the imaging condition (step S1201) for the entire imaging surface 200 of the imaging element 100 to the first imaging condition (ISO speed 100) by the user operating the operation unit 505, or automatically if the specific subject 700 is not detected in step S1214 (step S1214: Yes).

Also, the pre-processing unit 1010 sets the second imaging condition (ISO speed 200) for when the imaging condition is to be changed in step S1201. The pre-processing unit 1010 notifies the image processing unit 701 of the first imaging condition and the second imaging condition set in step S1201 (step S1202). As a result, the image processing unit 701 sets the processing content 834 to the first image processing and the second image processing (step S1203).

In Embodiment 1, the first imaging condition is an ISO speed of 100 and the second imaging condition is an ISO speed of 200. Thus, the image processing unit 701 performs, as the second image processing, correction in which “if the ISO speed is 100 in the first imaging region in which the specific subject 700 is captured, then the exposure of the image data of the corresponding first image region is raised by one level (+1.0EV).” Similarly, the image processing unit 701 performs, as the first image processing, correction in which “if the ISO speed is 200 in the second imaging region in which the specific subject 700 is predicted as being likely to be present, then the exposure of the image data of the corresponding second image region is lowered by one level (−1.0EV).”

As a result, in the imaging element 100, the imaging condition for the entire imaging surface 200 is set to the first imaging condition, and the imaging element 100 captures the subject under the first imaging condition and outputs video data 1201 including the series of frames F to the pre-processing unit 1010 (step S1205).

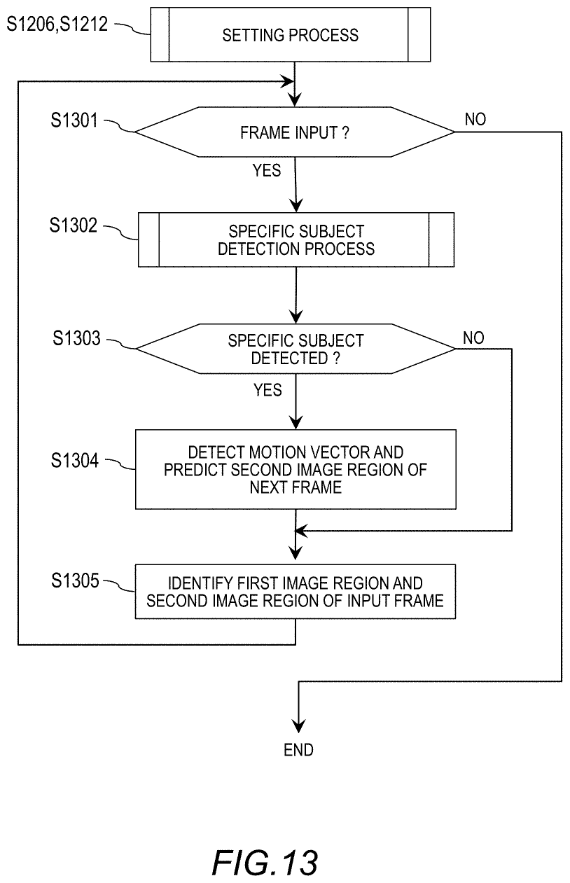

Upon receiving input of the video data 1201 (step S1205), the pre-processing unit 1010 executes a setting process (step S1206). In the setting process (step S1206), the detection of the specific subject 700, prediction of the second image region in the subsequent frame Fi+1, and the identification of the first image region and the second image region in the input frame Fi are executed. Details regarding the setting process (step S1206) will be described later with reference to FIG. 13.

Along with the image region in each frame Fi where the specific subject 700 is present and the additional information identifying the first image region and the second image region, the pre-processing unit 1010 outputs the video data 1201 to the image processing unit 701 (step S1207). In the present example, the specific subject 700 is considered not to have been detected in the video data 1201.

Also, if the second image region was not predicted (step S1208: No) in the subsequent input frame Fi+1 in the setting process (step S1206), then the pre-processing unit 1010 stands by for input of the video data 1201 of step S1205. On the other hand, if the position of the specific subject 700 of the subsequent input frame Fi+1 was predicted (step S1208: Yes) in the setting process (step S1206), then if the image region including the specific subject 700 is set to the first imaging condition (ISO speed 100), then the pre-processing unit 1010 changes the setting of the corresponding imaging region to the second imaging condition (ISO speed 200).

As a result, in the imaging element 100, the imaging condition for the imaging region corresponding to the image region predicted in the setting process (step S1206) among the entire imaging surface 200 is set to the second imaging condition. Also, the imaging element 100 captures the subject under the first imaging condition in the first imaging region and captures the subject under the second imaging condition in the second imaging region, and outputs the video data 1202 to the pre-processing unit 1010 (step S1211).

Upon receiving input of the video data 1202 (step S1211), the pre-processing unit 1010 executes a setting process (step S1212). The setting process of step S1212 is the same as the setting process of step S1206. Details regarding the setting process (step S1212) will be described later with reference to FIG. 13. Along with the image region in each frame Fi where the specific subject 700 is present and the additional information identifying the first image region and the second image region, the pre-processing unit 1010 outputs the video data 1202 to the image processing unit 701 (step S1213). In the video data 1202 of Embodiment 1, the specific subject 700 is considered to have been detected.

If the specific subject 700 is not detected (step S1214: Yes), then the pre-processing unit 1010 returns to step S1201 and changes the setting of the entire imaging surface 200 to the first imaging condition (step S1201). On the other hand, if the specific subject 700 is being continuously detected (step S1214: No), then the process returns to step S1209. In this case, the pre-processing unit 1010 changes the setting of the first imaging condition in step S1209 for imaging regions corresponding to the image regions where the specific subject 700 is no longer detected (step S1209).

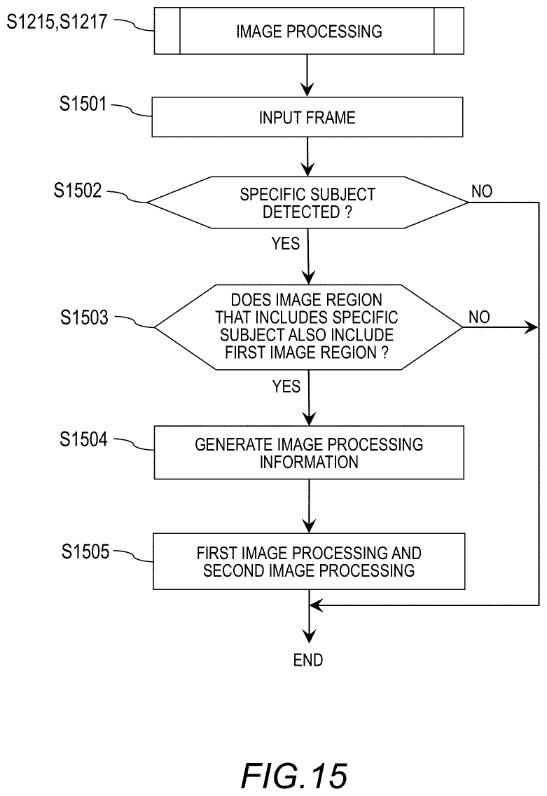

Also, upon receiving input of the video data 1201 (step S1207), the image processing unit 701 executes image processing with reference to the additional information (step S1215). Details regarding the image processing (step S1215) will be described later with reference to FIG. 15. In the video data 1201, the specific subject 700 is not detected, and thus, the image processing unit 701 outputs the frames F of the video data 1201 to the compression unit 702 without executing the second image processing (step S1216).

Also, upon receiving input of the video data 1202 (step S1213), the image processing unit 701 executes image processing with reference to the additional information (step S1217). In the image processing of step S1217, the image processing unit 701 executes the second image processing for image data of the image regions where the specific subject 700 is present. Details regarding the image processing of step S1217 will be described later with reference to FIG. 15. The image processing unit 701 outputs to the compression unit 702 the video data 1203 yielded by subjecting the video data 1202 to the second image processing (step S1218).

Upon receiving input of the video data 1201 (step S1216), the compression unit 702 executes a compression process on the video data 1201 (step S1219). Also, upon receiving input of the video data 1203 (step S1218), the compressed unit 702 executes a compression process on the video data 1203 (step S1220). In the video data 1203, the specific subject 700 is present in the second image regions predicted in the previous frame Fi−1 or the first image regions subjected to the second image processing, and thus, an equivalent brightness is maintained for the specific subject 700 in all of the frames F. Therefore, it is possible to increase block matching accuracy by the compression unit 702.

<Compensation Process (Steps S1206, S1212)>

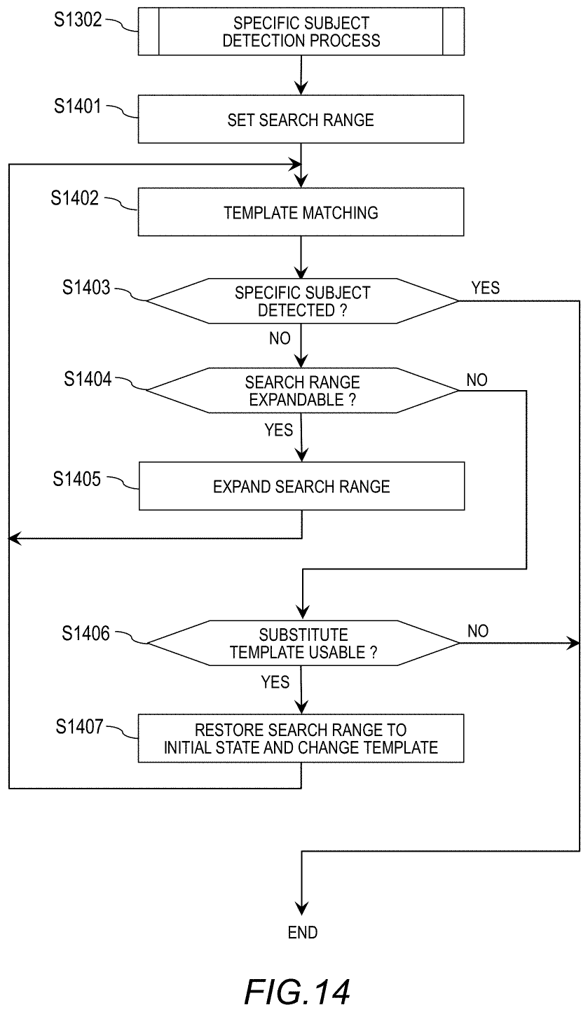

FIG. 13 is a flow chart showing an example of detailed process steps of the setting process (step S1206, S1212) shown in FIG. 12. The pre-processing unit 1010 awaits input of the frame Fi (step S1301), and if the frame Fi has been inputted (step S1301: Yes), then the detection unit 1011 executes a specific subject detection process (step S1302). The specific subject detection process (step S1302) is a process for detecting the specific subject 700 in the frame F. Details regarding the specific subject detection process (step S1302) will be described later with reference to FIG. 14.

The pre-processing unit 1010 determines whether the specific subject 700 has been detected by the detection unit 1011 (step S1303). If the specific subject 700 is not detected (step S1303: No), then the process progresses to step S1305. On the other hand, if the specific subject 700 has been detected (step S1303: Yes), then the pre-processing unit 1010 detects a motion vector according to the position of the specific subject 700 as detected in the immediately previous frame Fi−1 and the position of the specific subject 700 as currently detected by the detection unit 1011, and predicts the second image region where the specific subject 700 is likely to be detected in the subsequent frame Fi+1 on the basis of the size and direction of the motion vector (step S1304).

The pre-processing unit 1010 uses the setting unit 1012 to identify the image regions in the input frame Fi where the specific subject 700 is present, and the first image regions and the second image regions (predicted in frame Fi−1), stores the identified image regions as additional information to the frame Fi (step S1305), and returns to step S1301. The additional information is transmitted to the image processing unit 701 along with the video data. If there is no input of the frame Fi (step S1301: No), then the pre-processing unit 1010 ends the setting process.

As a result, it is possible to set the latest second imaging regions in the imaging element 100 and it is possible to image the moving destination of the subject in the second image regions. Also, it is possible to identify the specific subject 700 even if the specific subject 700 were to be outside of the second image regions in the frame Fi.

<Specific Subject Detection Process (Step S1302)>

FIG. 14 is a flow chart showing an example of detailed process steps of the specific subject detection process (step S1302) shown in FIG. 13. Here, the search range is set to Ri (i being an integer of 1 or greater). The greater the value of i is, the greater the search range Ri is. The detection unit 1011 sets the search range Ri to R1 (step S1401), and executes template matching in the search range Ri using a default template Tj (step S1402). The detection unit 1011 determines whether the specific subject 700 has been detected (step S1403).

If the specific subject 700 is detected (step S1403: Yes), the detection unit 1011 ends the specific subject detection process (step S1302). In this case, it is determined that the specific subject 700 has been detected in step S1303 of FIG. 13 (step S1303: Yes).

On the other hand, if the specific subject 700 was not detected (step S1403: No), then the detection unit 1011 determines whether the search range Ri can be expanded (step S1404). For example, if the expanded range Ri+1 after expansion exceeds a maximum range set in advance or the range of the frame, then it is determined that the search range cannot be expanded. If the search range Ri can be expanded (step S1404: Yes), then the detection unit 1011 expands the search range Ri by incrementing i (where i=1, for example, the search range R1 is expanded to the search range R2) (step S1405), transitions to step S1402, and attempts template matching at the search range Ri again (step S1402).

On the other hand, if the search range Ri cannot be expanded (step S1404: No), then the detection unit 1011 determines whether a substitute template can be used (step S1406). A substitute template is another unused template, for example. For example, where a used template is T1, an in-use template is T2, and an unused template is T3, then the substitute template is T3. Which substitute template can or cannot be used is set in advance.

If the substitute template cannot be used (step S1406: No), the detection unit 1011 ends the specific subject detection process (step S1302). In this case, it is determined that the specific subject 700 has not been detected in step S1303 of FIG. 13 (step S1303: No).

On the other hand, if the substitute template can be used (step S1406: Yes), then the detection unit 1011 restores the search range to the information set in step S1401, switches to the substitute template (step S1407), and returns to step S1402. In this manner, detection of the specific subject 700 is attempted for each frame F.

<Image Processing (Steps S1215, S1217)>

FIG. 15 is a flow chart showing an example of detailed process steps of the image processing (step S1215, S1217) shown in FIG. 12. The image processing unit 701 receives input of the frame Fi of the video data 1201 and 1203 (step S1501), and determines, according to the additional information of the input frame Fi, whether the specific subject 700 has been detected in the input frame Fi (step S1502). If the specific subject 700 has not been detected (step S1502: No), then the image processing unit 701 ends the image processing (steps S1215, S1217) without executing the first image processing or the second image processing.

On the other hand, if the specific subject 700 has been detected (step S1502: Yes), then the image processing unit 701 determines whether the image region including the image data of the specific subject 700 includes the first image region (step S1503). The following are possible cases: a case in which all of the image regions including the image data of the specific subject 700 are the first image regions (case 1); a case in which all of the image regions including the image data of the specific subject 700 are the second image regions (case 2); and a case in which the image regions including the image data of the specific subject 700 are both the first image regions and the second image regions (case 3).

For case 1, step S1503 returns “Yes,” and for case 2, step S1503 returns “No.” For case 3, if the first image regions are larger than the second image regions, step S1503 may return “Yes.” Also, if there is even one first image region, then step S1503 may return “Yes.” If step S1503 returns “No,” then the image processing unit 701 ends the image processing (steps S1215, S1217) without executing the first image processing or the second image processing.

On the other hand, if step S1503 returns “Yes,” then the image processing unit 701 uses the additional information to generate the image processing information 830 shown in FIG. 8 (step S1504). The image processing unit 701 then executes the first image processing and the second image processing shown in FIG. 7 (step S1505). Specifically, for example, the image processing unit 701 executes the second image processing for the first image region if image data of the specific subject 700 is present in the first image region, and executes the first image processing for the second image region if image data of the specific subject 700 is not present in the second image region predicted in the previous frame Fi−1. As a result, the image processing unit 701 completes the image processing (steps S1215, S1217).

<Playback Process>

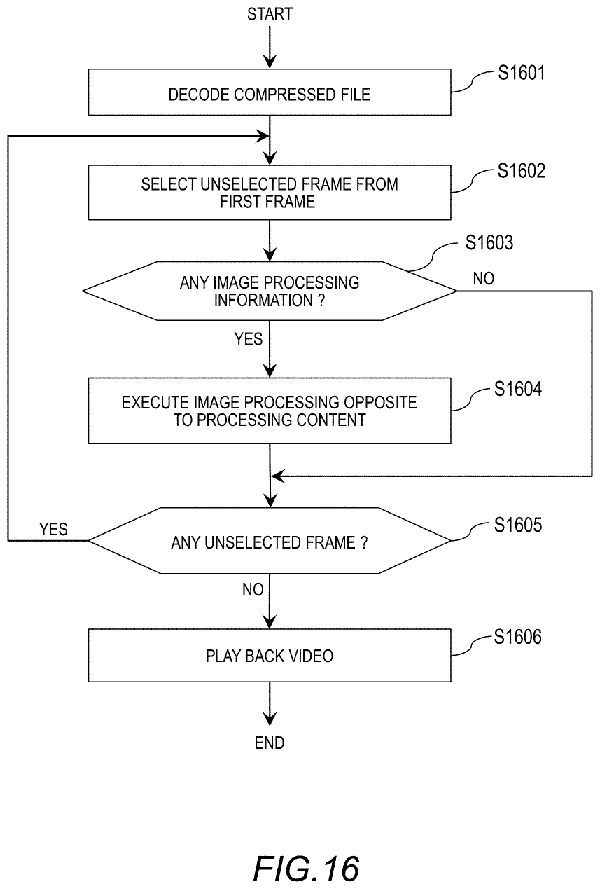

FIG. 16 is a flowchart showing an example of detailed process steps of the playback process for the video data. The decompression unit 901 reads from the storage device 703 and decompresses the compressed file 800 to be played back that was selected by the operation unit 505, and outputs the decompressed series of frames F to the image processing unit 701 (step S1601). The image processing unit 701 selects the unselected frame Fi from the head of the series of inputted frames F.

Then, the image processing unit 701 determines whether there is image processing information 830 for the selected frame Fi (step S1603). If there is no image processing information 830 (step S1603: No), then the process progresses to step S1605. On the other hand, if there is image processing information 830 for the selected frame Fi (step S1603: Yes), then the image processing unit 701 identifies the to-be-processed image region 832 and the processing content 834 in the image processing information 830 for the selected frame Fi, and executes on the to-be-processed image region 832 the inverse image processing to the processing content 834 of the image processing information 830 (step S1604).

The inverse image processing signifies that if the first image processing was performed prior to compression, then the second image processing is performed, and if the second image processing was performed prior to compression, then the first image processing is performed. If the processing content 834 is “+1.0EV,” then the image processing unit 701 executes a correction of “−1.0EV” as the inverse image processing, and if the processing content 834 is “−1.0EV,” then the image processing unit 701 executes a correction of “+1.0EV” as the inverse image processing, for example.

Thereafter, the image processing unit 701 determines whether there is an unselected frame F (step S1605), and if there is an unselected frame F (step S1605: Yes), then the process returns to step S1602 and the image processing unit 701 reselects the unselected frame F (step S1602). On the other hand, if there is no unselected frame F (step S1605: No), then the image processing unit 701 outputs the series of frames F to the playback unit 902, and the playback unit 902 plays back the series of frames F as the video data (step S1606). In this manner, the playback process is ended. Thus, according to Embodiment 1, if the specific subject 700 is detected by the detection unit 1011 in the second image region of the frame Fi predicted in the previous frame Fi−1, then the specific subject is captured in the second imaging region. Thus, the brightness of the specific subject 700 is equivalent among the frames Fi−1 and Fi, and it is possible to increase block matching accuracy in the compression unit 702.

Also, if the specific subject 700 is detected in the first image region instead of the second image region of the frame Fi predicted in the previous frame Fi−1, then the image processing unit 701 is off in its prediction of the position of the specific subject 700. Even in such a case, the image processing unit 701 executes the second image processing for the first image regions where the image data of the specific subject 700 is present. Thus, similar to a case in which the position of the specific subject 700 was predicted correctly, the brightness of the image data of the specific subject 700 is equivalent among the frames Fi−1 and Fi, and it is possible to increase block matching accuracy in the compression unit 702.

Also, if the position prediction for the specific subject 700 is off, then the image processing unit 701 executes the first image processing on the second image region. Thus, the image data of the first image region of the frame Fi−1 that is the source of the prediction is equivalent in brightness to the image data of the second image region subjected to the first image processing of the frame Fi that is the frame subject to prediction, and it is possible to improve block matching accuracy in the compression unit 702.

### Embodiment 2

Embodiment 2 is another example of the specific subject detection process (step S1302). In Embodiment 1, an example of a typical specific subject detection process (step S1302) was described, but in Embodiment 2, the image processing unit 701 executes the second image processing while executing the specific subject detection process (step S1302).

As a result, it is possible to improve the template matching accuracy. In Embodiment 2, the templates T1 to T3 include a template generated from the specific subject 700 extracted from the second image region or a template prepared in advance with an equivalent brightness thereto. Below, Embodiment 2 will be described, but only differences from Embodiment 1 will be described in Embodiment 2, and portions in common with Embodiment 1 are assigned the same reference characters and the same step numbers as Embodiment 1, with descriptions thereof being omitted.

<Specific Subject Detection Process (Step S1302)>

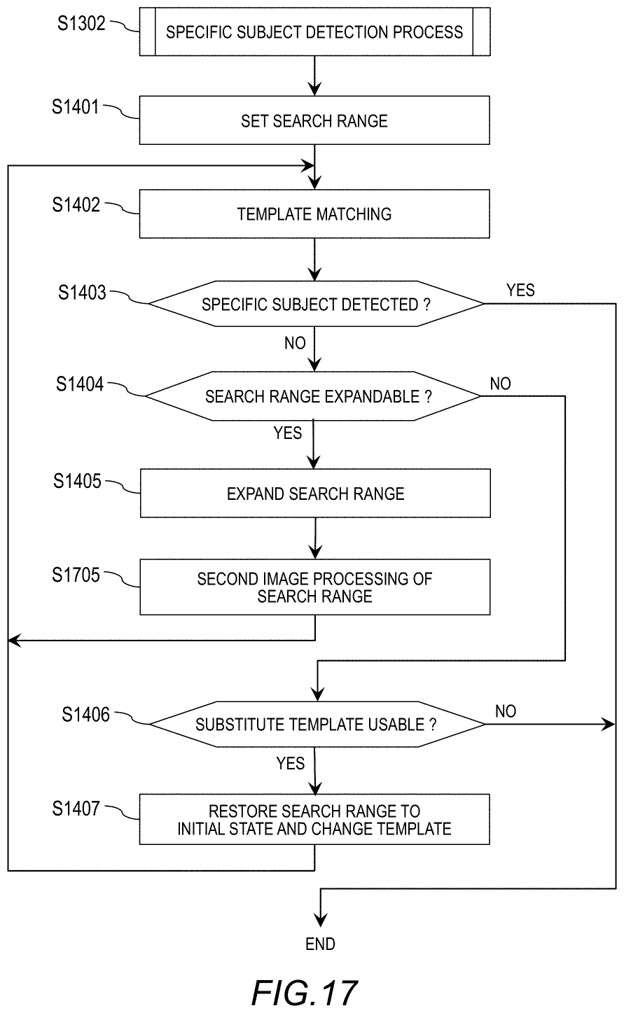

FIG. 17 is a flow chart showing an example according to Embodiment 2 of detailed process steps of the specific subject detection process (step S1302) shown in FIG. 13. After expanding the search range (step S1405), the detection unit 1011 uses the image processing unit 701 to execute the second image processing on the first image region in the search range (step S1705) and attempts template matching (step S1402).

As a result, the search range is equivalent in brightness to the templates T1 to T3, and it is possible to improve the template matching accuracy. In this manner, in Embodiment 2, detection of the specific subject 700 is attempted at a high accuracy for each frame F.

### Embodiment 3

Embodiment 3 is a video compression/decompression example for a case in which the first imaging region and the second imaging region are fixed in advance on the imaging surface 200. However, even if the first imaging region and the second imaging region were fixed, if the imaging region corresponding to the image region at the position of the image where the specific subject 700 is present in the subsequent frame Fi+1 is the first imaging region, the first imaging region is set to the second imaging region by the pre-processing unit 1010 in the setting process (steps S1206, S1212). For example, if the specific subject 700 is present in the second image region of the frame Fi and the specific subject 700 has moved to the first image region in the subsequent frame Fi+1, then the first imaging region where the specific subject 700 is present is set to the second imaging region by the pre-processing unit 1010.

As a result, in the second image region corresponding to the fixed second imaging region, image data of the specific subject 700 generated by being imaged under the second imaging condition (ISO speed 200) can be attained. Even if the specific subject 700 were to move to the fixed first imaging region and be captured in the first imaging region, the specific subject 700 is captured under the second imaging condition (ISO speed 200) in the dynamically set second imaging region. Thus, it is possible to increase block matching accuracy for the image data of the specific subject 700 present in the second image region among consecutive frames Fi−1 and Fi.

Also, if the first imaging region corresponding to the predicted second image region of the subsequent frame Fi+1 is set to the second imaging region by the pre-processing unit 1010, then there are cases in which the prediction of the position of the specific subject 700 is off and image data of the specific subject 700 is present in the first image region. Even in such a case, the image processing unit 701 executes the second image processing on the first image region and executes the first image processing on the second image region where the image data of the specific subject 700 was predicted not to be present.

As a result, it is possible to increase block matching accuracy for the image data of the specific subject 700 present in the second image region among consecutive frames Fi−1 and Fi and the image data of the specific subject 700 present in the first image region subjected to the second image processing.

In Embodiment 3, the positions and proportions of the first imaging region and the second imaging region in the imaging surface 200 are set arbitrarily. Also, in Embodiment 3, for ease of description, the explanation will be based on the first imaging region where the first imaging condition is set and the second imaging region where the second imaging condition is set, but there may be three or more imaging conditions and imaging regions set.

Below, Embodiment 3 will be described, but only differences from Embodiments 1 and 2 will be described in Embodiment 3, and portions in common with Embodiments 1 and 2 are assigned the same reference characters and the same step numbers as Embodiments 1 and 2, with descriptions thereof being omitted.

<Video Compression Example>

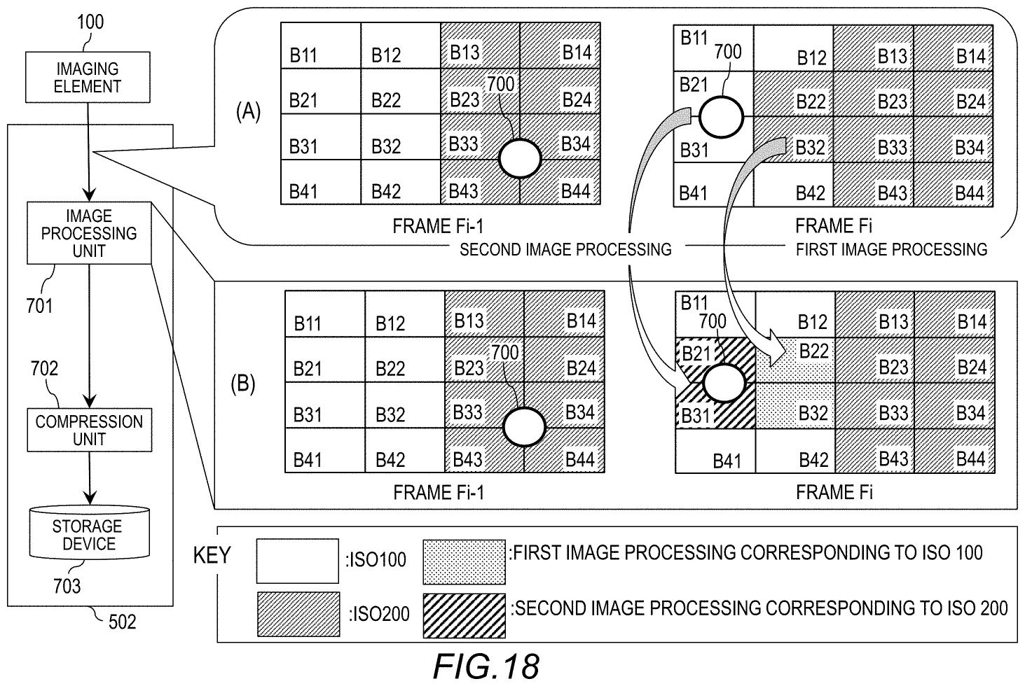

FIG. 18 is a descriptive drawing showing one example of video compression of Embodiment 3. In this video compression example, the imaging regions on the left half of the imaging surface 200 are set to be the first imaging regions and the imaging regions on the right half are set to be the second imaging regions. Thus, in the generated frames F, the image regions B11, B12, B21, B22, B31, B32, B41, and B42 are the first image regions outputted from fixed first imaging regions, and the image regions B13, B14, B23, B24, B33, B34, B43, and B44 are the second image regions outputted from fixed second imaging regions.

(A) Through detection of the specific subject 700 it is found that in the frame Fi−1, the specific subject 700 is present in the 2×2 lower right second image regions B33, B34, B43, and B44. The second image regions B33, B34, B43 and B44 are the second image regions corresponding to the fixed second imaging regions for which the second imaging condition (ISO speed 200) is set.

In the frame Fi, the specific subject 700 is present in the first image regions B21 and B31 in the center of the left edge. The first image regions B21 and B31 are the first image regions corresponding to the fixed first imaging regions for which the first imaging condition (ISO speed 100) is set. Also, the second image regions B22 and B32 on the center left side are the second image regions where it is predicted that the specific subject 700 would be present in the previous frame Fi−1.

(B) Through image processing, as described in Embodiment 1, the first image regions B21 and B31 of the frame Fi are subjected to the second image processing and the second image regions B22 and B32 are subjected to the first image processing. As a result, the second image regions B33, B34, B43, and B44 where the specific subject 700 is present in the frame Fi-1 are equivalent in brightness to the first image regions B21 and B31 subjected to the second image processing and where the specific subject 700 is present in the frame Fi, and thus, block matching accuracy in the compression unit 702 is improved.

Similarly, the first image regions B22 and B32 where the specific subject 700 is not present in the frame Fi−1 is equivalent in brightness to the second image regions B22 and B32 where the specific subject 700 is not present in the frame Fi and that is subjected to the first image processing, and thus, block matching accuracy in the compression unit 702 is improved.

<Decompression Example>

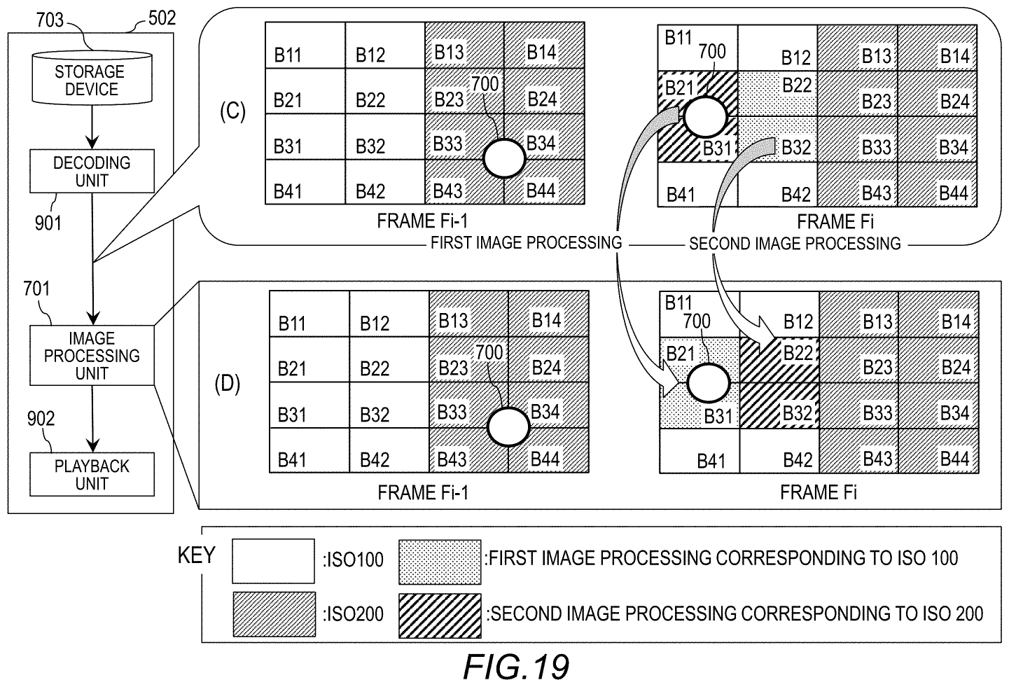

FIG. 19 is a descriptive drawing showing a decompression example of Embodiment 3. This decompression example corresponds to the video decompression example of FIG. 18. (C) shows the decompressed frames Fi−1 and Fi. The decompressed frames Fi−1 and Fi are the same as the frames Fi-1 and Fi after the image processing of (B) in FIG. 18. (D) shows an image processing example for the decompressed frame Fi. The image processing unit 701 refers to the image processing information 830 shown in FIG. 8 to execute the first image processing and the second image processing.

In the example of FIG. 19, similar to the case described in Embodiment 1, the image processing unit 701 executes the first image processing on the first image regions B21 and B31, which were subjected to the second image processing, and executes second image processing on the second image regions B22 and B32, which were subjected to the first image processing. As a result, the frame Fi of (D) is restored to the frame Fi of (A) in FIG. 18.

Thus, even if there are a plurality of imaging regions that are fixed in advance, it is possible to increase block matching accuracy to a high level by the compression unit 702 in a manner similar to Embodiments 1 and 2. Also, it is possible to improve reproducibility of the original frame F by restoring the frame to the original state.

### Embodiment 4

Embodiment 4, similar to Embodiment 3, is a video compression/decompression example for a case in which the first imaging region and the second imaging region are fixed in advance on the imaging surface 200. However, in Embodiment 4, setting of the second imaging regions by prediction of the second image regions is not executed.

Below, Embodiment 4 will be described, but only differences from Embodiment 3 will be described in Embodiment 4, and portions in common with Embodiment 3 are assigned the same reference characters and the same step numbers as Embodiment 3, with descriptions thereof being omitted.

<Video Compression Example>

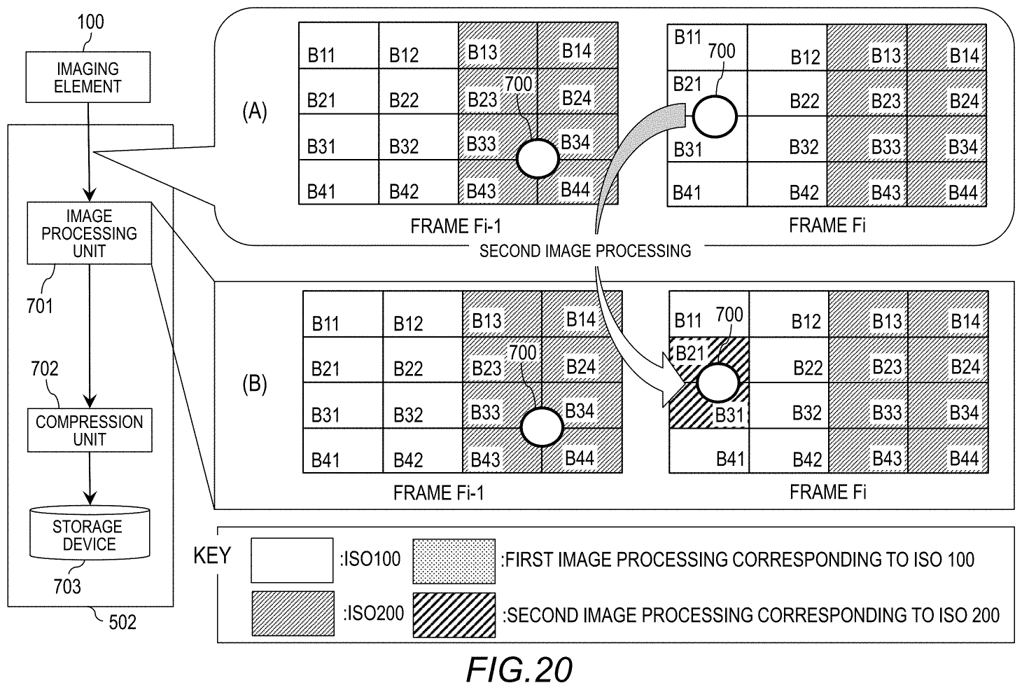

FIG. 20 is a descriptive drawing showing one example of video compression of Embodiment 4. The difference from Embodiment 3 is that the image regions B22 and B32 of (A) are not predicted as second image regions predicted in the previous frame Fi−1, and are first image regions corresponding to fixed first imaging regions. Therefore, regarding the image processing of (B) as well, the first image regions B21 and B31 of the frame Fi are subjected to the second image processing, but the image regions B22 and B32 are first image regions, and therefore, are not subjected to the first image processing.

As a result, the second image regions B33, B34, B43, and B44 where the specific subject 700 is present in the frame Fi−1 are equivalent in brightness to the first image regions B21 and B31 subjected to the second image processing and where the specific subject 700 is present in the frame Fi, and thus, block matching accuracy in the compression unit 702 is improved.

<Decompression Example>

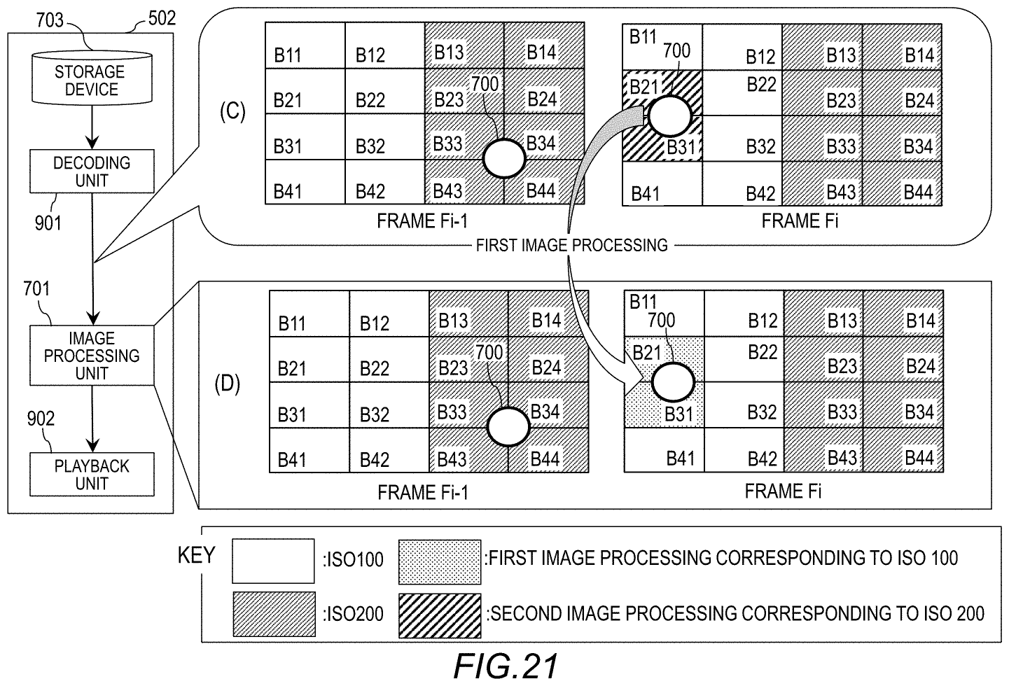

FIG. 21 is a descriptive drawing showing a decompression example of Embodiment 4. The image processing unit 701 executes the first image processing on the first image regions B21 and B31, which were subjected to the second image processing, but does not execute second image processing on the first image regions B22 and B32. As a result, the frame Fi of (D) is restored to the frame Fi of (A) in FIG. 20.

In the description above, an example was described of performing image processing of restoring to the original state the sections subjected to image processing (correction) after decompression when performing compression, but typically, the image regions where the specific subject 700 is present are regions captured under an ISO speed of 200, and thus, the first image processing need not be performed. Which image processing to perform may be selected by a user.

Thus, even if there are a plurality of imaging regions that are fixed in advance, and even if the specific subject 700 is detected in the first image region through specific subject detection, it is possible to increase block matching accuracy to a high level by the compression unit 702 in a manner similar to Embodiment 3. Also, it is possible to improve reproducibility of the original frame F by restoring the frame to the original state.

Also, the setting of the second imaging regions by prediction of the second image regions is not executed, and thus, the first image processing of the second image regions prior to compression and the second image processing after decompression are unnecessary, and thus, it is possible to reduce the processing load on the electronic apparatus 500.

### Embodiment 5

Embodiment 5, similar to Embodiment 4, is a video compression/decompression example for a case in which the first imaging region and the second imaging region are fixed in advance on the imaging surface 200, and setting of the second imaging regions by prediction of the second image regions is not executed.

However, if the specific subject 700 is detected in the first image region, then the second image processing is executed on the entirety of the fixed first imaging regions instead of executing the second image processing on only the first image regions where the specific subject 700 is present as in Embodiment 4. As a result, it is unnecessary to identify the first image regions where the specific subject 700 is present, and it is possible to improve pre-processing efficiency.

Below, Embodiment 5 will be described, but only differences from Embodiment 4 will be described in Embodiment 5, and portions in common with Embodiment 4 are assigned the same reference characters and the same step numbers as Embodiment 4, with descriptions thereof being omitted.

<Video Compression Example>

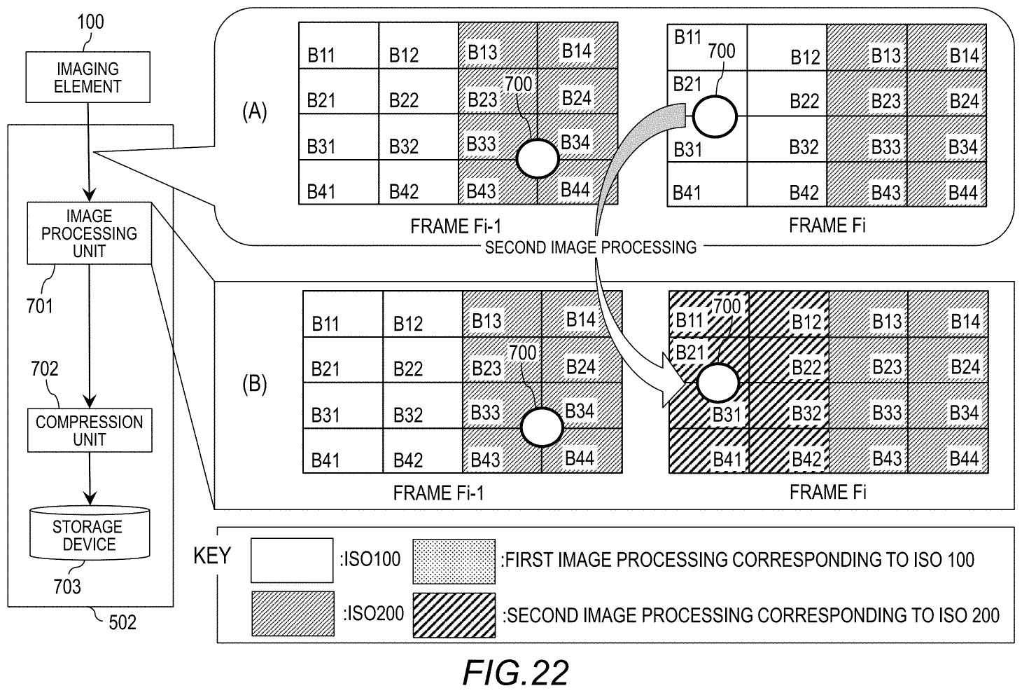

FIG. 22 is a descriptive drawing showing one example of video compression of Embodiment 5. The difference from Embodiment 5 is that in the frame Fi of (A), if the specific subject 700 is detected in the first image regions B21 and B31, then the image processing unit 701 executes the second image processing on all of the first image regions B11, B12, B21, B22, B31, B32, B41, and B42 corresponding to the fixed first imaging regions instead of executing the second image processing on only the first image regions B21 and B31.

As a result, block matching accuracy can be improved between the second image regions B33, B34, B43, and B44 where specific subject 700 was detected in the frame Fi−1 and the first image regions B11, B12, B21, B22, B31, B32, B41, and B42 subjected to the second image processing. Also, it is unnecessary to identify the first image regions where the specific subject 700 is present, and it is possible to improve pre-processing efficiency.

<Decompression Example>

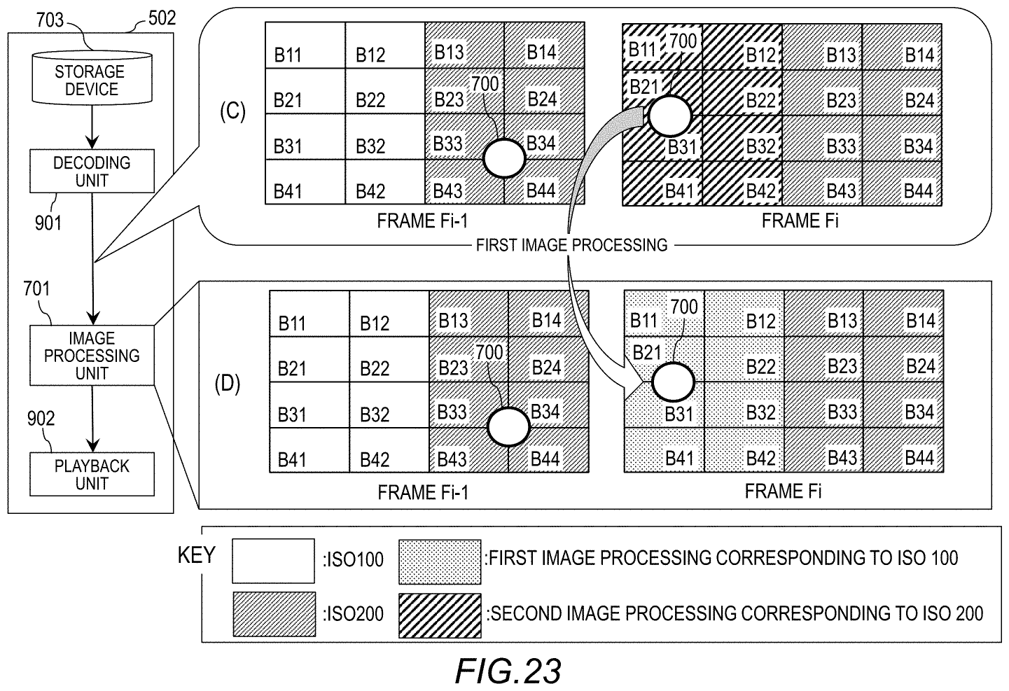

FIG. 23 is a descriptive drawing showing a decompression example of Embodiment 5. The image processing unit 701 executes the first image processing on the first image regions B11, B12, B21, B22, B31, B32, B41, and B42, which were subjected to the second image processing. As a result, the frame Fi of (D) is restored to the frame Fi of (A) in FIG. 22.

Thus, even if there are a plurality of imaging regions that are fixed in advance, and even if the specific subject 700 is detected in the first image region through specific subject detection, it is possible to increase block matching accuracy to a high level in a manner similar to Embodiment 4. Also, it is possible to improve reproducibility of the original frame F by restoring the frame to the original state.

Also, the setting of the second imaging regions by prediction of the second image regions is not executed, and thus, the first image processing of the second image regions prior to compression and the second image processing after decompression are unnecessary, and thus, it is possible to reduce the processing load on the electronic apparatus. Also, it is unnecessary to identify the first image regions where the specific subject 700 is present, and it is possible to improve pre-processing efficiency.

(1) As described above, the video compression apparatus according to the embodiments compresses a plurality of frames F outputted from an imaging element 100 that has a first imaging region in which a subject is captured and a second imaging region in which a subject is captured, and in which a first imaging condition (ISO speed 100, for example) can be set for the first imaging region and a second imaging condition (ISO speed 200, for example) differing from the first imaging condition can be set for the second imaging region.

The video compression apparatus has an image processing unit 701 configured to execute image processing based on the second imaging condition on image data outputted from the first imaging region by the imaging element 100 capturing the subject, and a compression unit 702 configured to compress a frame Fi on which the image processing was executed by the image processing unit 701 on the basis of block matching with a frame Fi−1 (or another frame) that differs from the frame Fi. As a result, it is possible to increase block matching accuracy by the compression unit 702.

(2) Also, in (1), if the specific subject 700 is within the first imaging region, the image processing unit 701 is configured to execute image processing based on the second imaging condition on the image data of the specific subject 700 in a first image region outputted from the first imaging region. As a result, it is possible to execute image processing (correction) on the specific subject 700 within the first image region so as to appear as though the specific subject 700 were captured under the second imaging condition, and it is possible to improve block matching accuracy in the compression unit 702.

(3) Also, in (1), if the specific subject 700 is within the first imaging region, the image processing unit 701 is configured to execute image processing based on the first imaging condition on the image data in a second image region outputted from the second imaging region. As a result, it is possible to execute image processing (correction) on the second image region where the specific subject 700 is not present so as to appear as though the second image region were captured under the first imaging condition, and it is possible to improve block matching accuracy in the compression unit 702.

(4) Also, in (1), if the specific subject 700 is within the second imaging region, the image processing unit 701 is configured not to execute image processing based on the second imaging condition for image data of the specific subject 700 within the second image region outputted from the second imaging region. As a result, it is possible to mitigate unnecessary image processing on the specific subject 700 within the second image region and to increase the efficiency of the image processing.

(5) The video compression apparatus of (1) has a detection unit 1011 that detects the specific subject 700 among the subjects, wherein the image processing unit 701 is configured to execute image processing based on the second imaging condition for image data of the specific subject 700 detected by the detection unit 1011. As a result, it is possible to track the specific subject 700 for each frame F, and to increase block matching accuracy by the compression unit 702.

(6) Also, in (5), when the specific subject 700 is detected by the detection unit 1011 as being within the first image region (B21, B31, for example) outputted from the first imaging region, the image processing unit 701 is configured to execute image processing based on the second imaging condition for the image data of the specific subject 700. As a result, it is possible to execute image processing (correction) on the specific subject 700 detected in the first image region so as to appear as though the specific subject 700 were captured under the second imaging condition, and it is possible to improve block matching accuracy in the compression unit 702.

(7) Also, in (6), when the specific subject 700 is detected by the detection unit 1011 as being within the first image region outputted from the first imaging region, the image processing unit 701 is configured to execute image processing based on the first imaging condition for the image data of the second image region outputted from the second imaging region. As a result, it is possible to execute image processing (correction) on the second image region where the specific subject 700 was not detected so as to appear as though the second image region were captured under the first imaging condition, and it is possible to improve block matching accuracy in the compression unit 702.

(8) Also, in (5), when the specific subject 700 is detected by the detection unit 1011 as being within the second image region outputted from the second imaging region, the image processing unit 701 is configured not to execute image processing based on the second imaging condition for the image data of the specific subject 700. As a result, it is possible to mitigate unnecessary image processing on the specific subject 700 detected in the second image region and to increase the efficiency of the image processing.

(9) Also, in (5), if the specific subject 700 is not detected by the detection unit 1011 within the first search range R1 within the frame F, the image processing unit 701 is configured to execute image processing based on the second imaging condition for image data of the first search range R1, and the detection unit 1011 reattempts detection of the specific subject 700 within the first search range R1 subjected to image processing by the image processing unit 701. As a result, it is possible to improve the detection efficiency for the specific subject.

(10) Also, in (5), if the specific subject 700 is not detected within the first search range R1 within the frame F by the detection unit 1011, the image processing unit 701 is configured to execute image processing based on the second imaging condition for image data in the second search range R2, which is yielded by expanding the first search range R1, and the detection unit 1011 is configured to reattempt detection of the specific subject 700 in the second search range R2 that was subjected to image processing based on the second imaging condition. As a result, it is possible to improve the detection efficiency for the specific subject.

(11) The video compression apparatus of (1) further includes a setting unit 1012 configured to set the second imaging region on the basis of the specific subject 700 detected in two frames Fi−2 and Fi−1 preceding the frame Fi. As a result, it is possible to dynamically set the second image region corresponding to the set second imaging region, and it is possible to predict the position of the specific subject 700.

(12) Also, in (11), if the specific subject 700 is outside of the second image region outputted from the second imaging region set by the setting unit 1012, the image processing unit 701 is configured to execute image processing based on the second imaging condition on the image data of the specific subject 700. As a result, even if the prediction of the second image region is off, it is possible to execute image processing (correction) on the specific subject 700 detected in the first image region so as to appear as though the specific subject 700 were captured under the second imaging condition, and it is possible to improve block matching accuracy in the compression unit 702.

(13) Also, in (12), if the image data of the specific subject 700 is outside of the second image region (B22, B32, for example) outputted from the second imaging region set by the setting unit 1012, the image processing unit 701 is configured to execute image processing based on the first imaging condition for the image data of the second image region. As a result, even if the prediction of the second image region set by the setting unit 1012 were off, it is possible to execute image processing (correction) on the second image region so as to appear as though the second image region were captured under the first imaging condition, and it is possible to improve block matching accuracy in the compression unit 702.

(14) Also, in (11), if the image data of the specific subject 700 is within the second image region outputted from the second imaging region set by the setting unit 1012, the image processing unit 701 is configured not to execute image processing based on the second imaging condition for the specific subject 700. As a result, it is possible to mitigate unnecessary image processing on the specific subject 700 detected in the second image region and to increase the efficiency of the image processing.

(15) The video compression apparatus of (1) has a generation unit 1013 configured to generate a compressed file 800 including a compressed frame that was compressed by the compression unit 702, and information pertaining to image processing executed on image data of the specific subject 700. As a result, it is possible to restore the frame F prior to compression when decompressing the frame F.

(16) In (15), a decompression unit 901 is configured to decompress the compressed frame within the compressed file 800 generated by the generation unit 1013 to the frame F is provided, and the image processing unit 701 is configured to execute image processing based on change from the second imaging condition to the first imaging condition for image data of the specific subject 700 that was subjected to image processing based on the second imaging condition within the frame F decompressed by the decompression unit 901 using information pertaining to the image processing executed on the image data of the specific subject 700. As a result, it is possible to restore the decoded frame F to the state prior to compression.

### EXPLANATION OF REFERENCES

100 imaging element, 200 imaging face, 500 electronic apparatus, 502 control unit, 700 specific subject, 701 image processing unit, 702 compression unit, 703 storage device, 800 compressed file, 830 image processing information, 901 decompression unit, 902 playback unit, 1010 pre-processing unit, 1011 detection unit, 1012 setting unit, 1013 generation unit

1. A video compression apparatus configured to compress a plurality of frames outputted from an imaging element that has a first imaging region in which a subject is captured and a second imaging region in which a subject is captured, and in which a first imaging condition can be set for the first imaging region and a second imaging condition differing from the first imaging condition can be set for the second imaging region, the video compression apparatus comprising:
an image processing unit configured to execute image processing based on the second imaging condition on image data outputted from the first imaging region by the imaging element capturing the subject; and
a compression unit configured to compress each of the frames subjected to the image processing by the image processing unit on the basis of block matching with a frame differing from the frame.

2. The video compression apparatus according to claim 1,
wherein, if a specific subject is within the first imaging region, the image processing unit is configured to execute image processing based on the second imaging condition on the image data of the specific subject in a first image region outputted from the first imaging region.

3. The video compression apparatus according to claim 1,
wherein, if a specific subject is within the first imaging region, the image processing unit is configured to execute image processing based on the first imaging condition on image data of a second image region outputted from the second imaging region.

4. The video compression apparatus according to claim 1,
wherein, if a specific subject is within the second imaging region, the image processing unit is configured not to execute image processing based on the second imaging condition on the image data of the specific subject in the second image region outputted from the second imaging region.

5. The video compression apparatus according to claim 1, further comprising:
a detection unit configured to detect a specific subject among the subjects,
wherein the image processing unit is configured to execute image processing based on the second imaging condition for image data of the specific subject detected by the detection unit.

6. The video compression apparatus according to claim 5,
wherein, if the specific subject is detected by the detection unit as being within a first image region outputted from the first imaging region, the image processing unit is configured to execute image processing based on the second imaging condition on the image data of the specific subject.

7. The video compression apparatus according to claim 6,
wherein, if the specific subject is detected by the detection unit as being in the first image region outputted from the first imaging region, then the image processing unit is configured to execute image processing based on the first imaging condition for image data of the second image region outputted from the second imaging region.

8. The video compression apparatus according to claim 5,
wherein, if the specific subject is detected by the detection unit as being within a second image region outputted from the second imaging region, the image processing unit is configured not to execute image processing based on the second imaging condition on the image data of the specific subject.

9. The video compression apparatus according to claim 5,
wherein, if the specific subject is not detected within a first search range in the frame by the detection unit, the image processing unit is configured to execute image processing based on the second imaging condition on the image data within the first search range, and
wherein the detection unit is configured to detect the specific subject within the first search range that was subjected to image processing by the image processing unit.

10. The video compression apparatus according to claim 5,
wherein, if the specific subject is not detected within the first search range within the frame by the detection unit, the image processing unit is configured to execute image processing based on the second imaging condition for image data in a second search range yielded by expanding the first search range, and
wherein the detection unit is configured to detect the specific subject in the second search range that was subjected to image processing based on the second imaging condition.

11. The video compression apparatus according to claim 1, further comprising:
a setting unit configured to set the second imaging region on the basis of a specific subject detected in two frames preceding the frame.

12. The video compression apparatus according to claim 11,
wherein, if image data of the specific subject is outside of the second image region outputted from the second imaging region set by the setting unit, the image processing unit is configured to execute image processing based on the second imaging condition on the image data of the specific subject.

13. The video compression apparatus according to claim 12,
wherein, if image data of the specific subject is outside of the second image region outputted from the second imaging region set by the setting unit, the image processing unit is configured to execute image processing based on the first imaging condition on image data of the second image region.

14. The video compression apparatus according to claim 11,
wherein, if image data of the specific subject is within the second image region outputted from the second imaging region set by the setting unit, the image processing unit is configured not to execute image processing based on the second imaging condition on the image data of the specific subject.

15. The video compression apparatus according to claim 1, further comprising:
a generation unit configured to generate a compressed file including a compressed frame that was compressed by the compression unit, and information pertaining to image processing executed on image data of a specific subject.

16. The video compression apparatus according to claim 15, further comprising:
a decompression unit configured to decompress the compressed frame within the compressed file generated by the generation unit into the frame,
wherein the image processing unit is configured to use the information pertaining to image processing executed on the image data of the specific subject to execute image processing based on the second imaging condition and the first imaging condition for the image data of the specific subject that was subjected to image processing based on the second imaging condition within the frame decompressed by the decompression unit.

17. A video compression apparatus configured to compress a plurality of frames outputted from an imaging element that has a first imaging region in which a subject is captured and a second imaging region in which a subject is captured, and in which a first imaging condition can be set for the first imaging region and a second imaging condition differing from the first imaging condition can be set for the second imaging region, the video compression apparatus comprising:
an image processing unit configured to execute image processing based on the second imaging condition on image data outputted from the first imaging region by the imaging element capturing the subject; and
a compression unit configured to compress each of the frames subjected to the image processing by the image processing unit on the basis of a frame differing from the frame.

18. A decompression apparatus configured to decompress a compressed file having compressed therein a plurality of frames outputted from an imaging element that has a first imaging region in which a subject is captured and a second imaging region in which a subject is captured, and in which a first imaging condition can be set for the first imaging region and a second imaging condition differing from the first imaging condition can be set for the second imaging region, the decompression apparatus, comprising:
a decompression unit configured to decompress the compressed frame within the compressed file into the frame; and
wherein the image processing unit is configured to execute image processing based on the second imaging condition and the first imaging condition for image data of a specific subject subjected to image processing based on the second imaging condition within the frame decompressed by the decompression unit.

19. (canceled)

20. (canceled)

21. A processor-readable recording medium having recorded therein a video compression program that causes a processor to execute compression on a plurality of frames outputted from an imaging element that has a first imaging region in which a subject is captured and a second imaging region in which a subject is captured, and in which a first imaging condition can be set for the first imaging region and a second imaging condition differing from the first imaging condition can be set for the second imaging region,
wherein the program causes the processor to execute:
image processing based on the second imaging condition on image data outputted from the first imaging region by the imaging element capturing the subject; and
compression of each of the frames subjected to the image processing on the basis of a frame differing from the frame.

22. A processor-readable recording medium having recorded therein a decompression program that causes a processor to decompress a compressed file having compressed therein a plurality of frames outputted from an imaging element that has a first imaging region in which a subject is captured and a second imaging region in which a subject is captured, and in which a first imaging condition can be set for the first imaging region and a second imaging condition differing from the first imaging condition can be set for the second imaging region,
wherein the program causes the processor to execute:
decompression of the compressed frame within the compressed file to the frame; and
image processing based on the second imaging condition and the first imaging condition for image data of a specific subject that was subjected to image processing based on the second imaging condition within the decompressed frame.
